(19) United States
(12) Patent Application Publication
(10) Pub. No.: US 2026/0342529 A1
(43) Pub. Date: Oct. 29, 2026

(54) RESOURCE CONFIGURATION METHOD, SYSTEM AND APPARATUS, COMMUNICATION DEVICE, AND STORAGE MEDIUM

(71) Applicant: Beijing Xiaomi Mobile Software Co., Ltd., Beijing (CN)

(72) Inventor: Lei WANG, Beijing (CN)

(21) Appl. No.: 19/484,705

(22) PCT Filed: May 15, 2023
(86) PCT No.: PCT/CN2023/094355

§ 371 Date: Nov. 14, 2025

(51) Int. Cl. H04L 5/00

(52) U.S. Cl. CPC H04L 5/0098; H04L 5/0044

(57) ABSTRACT

A method for configuring a resource, including: receiving first information sent by a network device; and determining a first category of a first time unit of a carrier component (CC) according to the first information, where the first category is one of a subband full duplex (SBFD) category, a downlink (DL) category, an uplink (UL) category, and a flexible (F) category.

### CROSS-REFERENCE TO RELATED APPLICATION

The present application is a U.S. National Stage of International Application No. PCT/CN2023/094355, filed on May 15, 2023, the contents of all of which are incorporated herein by reference in their entireties for all purposes.

### BACKGROUND OF THE INVENTION

In order to improve coverage and throughput of an uplink (UL), subband full duplex (SBFD) is studied in a Rel-18 duplex enhancement project. Specifically, a frequency domain of a carrier component (CC) is divided into a plurality of subbands (SBs) on a downlink (DL) symbol or a flexible (F) symbol. The plurality of SBs include one UL subband and at least one DL subband. A base station can send a DL signal on the DL subband and receive a UL signal on the UL subband at the same time.

### SUMMARY OF THE INVENTION

The present disclosure relates to the technical field of communication, and in particular, to a method and system for configuring a resource, a device, a communication device, and a storage medium.

According to a first aspect of the embodiments of the present disclosure, a method for configuring a resource is provided. The method is performed by a terminal and includes:
receiving first information sent by a network device; and
determining a first category of a first time unit of a carrier component (CC) according to the first information, where the first category is one of a subband full duplex (SBFD) category, a downlink (DL) category, an uplink (UL) category, and a flexible (F) category.

According to a second aspect of the embodiments of the present disclosure, a method for configuring a resource is provided. The method is performed by a network device and includes:

sending first information to a terminal, where the first information is configured to indicate a first category of a first time unit of a carrier component (CC), and the first category is one of a subband full duplex (SBFD) category, a downlink (DL) category, an uplink (UL) category, and a flexible (F) category.

According to a third aspect of the embodiments of the present disclosure, a communication device is provided. The communication device includes:
one or more processors; and
a memory that stores computer instructions, where the computer instructions, when collectively executed by the one or more processors, cause the communication device to perform the method for configuring a resource provided in the first aspect or the second aspect.

According to a fourth aspect of the embodiments of the present disclosure, a non-transitory computer-readable storage medium is provided. The computer-readable storage medium stores computer instructions. The computer instructions, when collectively executed by one or more processors, implement the method for configuring a resource provided in the first aspect or the second aspect.

### BRIEF DESCRIPTION OF DRAWINGS

FIG. 1 is a schematic diagram of subband full duplex (SBFD) symbols/slots according to an embodiment of the present disclosure;

FIG. 2a is a schematic diagram of a slot format configuration of a carrier component (CC) according to an embodiment of the present disclosure;

FIG. 2b is a schematic diagram of a slot format configuration of an uplink (UL) subband according to an embodiment of the present disclosure;

FIG. 3 is a schematic structural diagram of a system for configuring a resource according to an embodiment of the present disclosure;

FIG. 4 is an interactive schematic diagram of a method for configuring a resource according to an embodiment of the present disclosure;

FIG. 5a is a schematic flowchart of a method for configuring a resource according to an embodiment of the present disclosure;

FIG. 5b is a schematic flowchart of a method for configuring a resource according to an embodiment of the present disclosure;

FIG. 5c is a schematic flowchart of a method for configuring a resource according to an embodiment of the present disclosure;

FIG. 5d is a schematic flowchart of a method for configuring a resource according to an embodiment of the present disclosure;

FIG. 5e is a schematic flowchart of a method for configuring a resource according to an embodiment of the present disclosure;

FIG. 5f is a schematic flowchart of a method for configuring a resource according to an embodiment of the present disclosure;

FIG. 5g is a schematic flowchart of a method for configuring a resource according to an embodiment of the present disclosure;

FIG. 5h is a schematic flowchart of a method for configuring a resource according to an embodiment of the present disclosure;

FIG. 5i is a schematic flowchart of a method for configuring a resource according to an embodiment of the present disclosure;

FIG. 5j is a schematic flowchart of a method for configuring a resource according to an embodiment of the present disclosure;

FIG. 5k is a schematic flowchart of a method for configuring a resource according to an embodiment of the present disclosure;

FIG. 5l is a schematic flowchart of a method for configuring a resource according to an embodiment of the present disclosure;

FIG. 5m is a schematic flowchart of a method for configuring a resource according to an embodiment of the present disclosure;

FIG. 5n is a schematic flowchart of a method for configuring a resource according to an embodiment of the present disclosure;

FIG. 6 is a schematic flowchart of a method for configuring a resource according to an embodiment of the present disclosure;

FIG. 7 is a schematic structural diagram of a first communication device according to an embodiment of the present disclosure;

FIG. 8 is a schematic structural diagram of a second communication device according to an embodiment of the present disclosure; and

FIG. 9 is a schematic structural diagram of a communication device according to an embodiment of the present disclosure.

### DETAILED DESCRIPTION OF THE INVENTION

The embodiments of the present disclosure provide a method and system for configuring a resource, a device, a communication device, and a storage medium. In some embodiments, terms such as a method for configuring a resource, a method for allocating a time domain resource, a method for allocating a time frequency resource, and a method for processing a resource are interchangeable. Terms such as a communication device, a device for allocating a time domain resource, a device for allocating a time frequency resource, a device for configuring a resource, and a device for processing a resource are interchangeable. Terms such as a system for configuring a resource, a communication system, a system for allocating a time domain resource, a system for allocating a time frequency resource, and a system for processing a resource are interchangeable.

The embodiments of the present disclosure are not exhaustive, merely illustrative of some embodiments, and not intended to be specific limitations on the scope of protection of the present disclosure. In a case of no contradiction, each step in an embodiment can be implemented as an independent embodiment, and steps can be freely combined. For example, a solution with some steps removed in an embodiment can also be implemented as an independent embodiment, and an order of steps in an embodiment can be freely exchanged. Moreover, optional implementations in an embodiment can be freely combined. In addition, embodiments can be freely combined. For example, some or all steps in different embodiments can be freely combined, and an embodiment can be freely combined with optional implementations in other embodiments.

Terms used in the embodiments of the present disclosure are only for the purpose of describing particular embodiments and are not intended to limit the present disclosure. In the embodiments of the present disclosure, the singular expressions “a,” “an,” “one,” “this,” “the above,” “the,” “the aforementioned,” “such a,” etc., further include plural expressions, unless clearly indicated to the contrary in the context. Pre-definition in the embodiments of the present disclosure can be understood as definition, early definition, storage, pre-storage, pre-negotiation, pre-configuration, solidification, or pre-firing, etc.

Prefix words such as “first” and “second” in the embodiments of the present disclosure are only configured to distinguish different described objects, and have no limitation on the location, order, priority, number or content of the described objects. For example, if a described object is a “field,” ordinal numbers before the “field” in a “first field” and a “second field” do not limit a location or order of the “field.” The “first” and “second” do not limit whether the modified “field” is in the same message and do not limit an order of the “first field” and the “second field.” For another example, if a described object is a “grade,” ordinal numbers before the “grade” in a “first grade” and a “second grade” do not limit the priority of the “grade.” For yet another example, a number of described objects is not limited by ordinal numbers, and may be one or more. With a “first device” as an example, a number of devices may be one or more. In addition, the objects modified by different prefix words may be the same or different. For example, if a described object is a “device,” a “first device” and a “second device” may be devices in the same type or devices in different types. For another example, if a described object is “information,” “first information” and “second information” may be information having the same content or information having different content. In conclusion, the usage of prefix words, such as ordinal numbers, for distinguishing described objects in the embodiments of the present disclosure does not limit the described objects. Statements of the described objects can be obtained with reference to descriptions of context in the claims or embodiments. No redundant limitation caused by the usage of such prefix words should be constituted.

In the embodiments of the present disclosure, “plurality of” refers to two or more. In the embodiments of the present disclosure, the term “and/or” for describing an association relationship between associated objects indicates that three relationships can exist independently. For instance, A and/or B can denote A exits alone, B exits alone, and both A and B exit. The description, such as at least one of “A1, A2, . . . , or An”, in the embodiments of the present disclosure includes a case that any one of A1, A2, . . . , An exists alone, and further includes a case that any plurality of A1, A2, . . . , An are freely combined, and each case can exist alone. For example, the description of “at least one of A, B, or C” includes A alone, B alone, C alone, a combination of A and B, a combination of A and C, a combination of B and C, and a combination of A and B and C.

In some embodiments, the recitations “A in a case, and B in another case,” etc. may include, according to situations, solutions as follows: A is performed independently of B, that is, A in some embodiments; B is performed independently of A, that is, B in some embodiments; A and B are selectively performed, that is, A and B are selectively performed in some embodiments; and A and B are performed, that is, A and B in some embodiments. The situations are similar in a case where more branches A, B, C, etc. exist.

In some embodiments, terms “in a case where . . . ,” “in response to determining . . . ,” “in a situation . . . ,” “in a case . . . ,” “when,” “if . . . ,” “under the condition . . . ,” etc. are interchangeable.

In some embodiments, “including A,” “having A,” “for indicating A,” and “carrying A” may be interpreted as directly carrying A or indirectly indicating A.

In some embodiments, terms “greater than,” “greater than or equal to,” etc. are interchangeable.

In some embodiments, terms “device,” “device,” “system,” “chip,” “system on a chip,” etc. are interchangeable.

In some embodiments, terms “access network device (AN device),” “radio access network device (RAN device),” “base station (BS),” “radio base station,” “carry,” “component carrier,” “carrier component,” “bandwidth part (BWP),” etc., are interchangeable.

In some embodiments, terms “terminal,” “terminal device,” “user equipment (UE),” “user terminal,” “mobile station (MS),” “mobile terminal (MT),” “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” etc. are interchangeable.

In some embodiments, an access network device, a core network device, or a network device can be replaced with a terminal. For example, in a case of a structure in which communication between an access network device, a core network device, or a network device and a terminal is replaced with communication (which may be referred to as device-to-device (D2D), vehicle-to-everything (V2X), etc. for example) among a plurality of terminals, embodiments of the present disclosure may be applied. In this case, the terminal may be set to have a structure having all or some functions of the access network device. Languages such as “uplink” and “downlink” may be replaced with languages corresponding to communication between terminals (such as “side”). For example, an uplink channel, a downlink channel, etc. may be replaced with side channels. An uplink, a downlink, etc. may be replaced with side links.

In some embodiments, the terminal may be replaced with the access network device, the core network device, or the network device. In this case, the access network device, the core network device, or the network device may be set to have a structure having all or some functions of the terminal.

In some embodiments, a name of information, etc. is not limited to a name described in the embodiments. Terms “information,” “message,” “signal,” “signaling,” “report,” “configuration,” “indication,” “instruction,” “command,” “channel,” “parameter,” “domain,” “field,” “symbol,” “symbol,” “codebook,” “codeword,” “codepoint,” “bit,” “data,” “program,” “chip,” etc. are interchangeable.

In some embodiments, terms “frame,” “radio frame,” “subframe,” “slot,” “sub-slot,” “mini-slot,” “symbol,” “symbol,” “transmission time interval (TTI),” etc. are interchangeable.

In some embodiments, terms “acquire,” “obtain,” “get,” “receive,” “transmit,” “bidirectionally transmit,” and “send and/or receive” are interchangeable, and may be interpreted as receiving from another main body, acquiring from a protocol, processing by themselves, implementing autonomously, etc.

In some embodiments, terms “send,” “emit,” “report,” “issue,” “transmit,” “bidirectionally transmit,” “send and/or receive,” etc. are interchangeable.

In some embodiments, “predetermined” and “preset” may be interpreted as being stipulated in a protocol, etc., or may be interpreted as performing a preset action by a device, etc.

In some embodiments, “determining” may be interpreted as “distinguishing,” “deciding,” “judging,” “calculating,” “computing,” “processing,” “deriving,” “investigating,” “researching,” “looking up,” “search,” “inquiry,” “ascertaining,” “receiving,” “transmitting,” “input,” “output,” “accessing,” “resolving,” “selecting,” “choosing,” “establishing,” “comparing,” “assuming,” “expecting,” “considering,” “broadcasting,” “notifying,” “communicating,” “forwarding,” “configuring,” “reconfiguring,” “allocating,” “mapping,” “allocating,” “mapping,” “assigning,” etc., but is not restrictive.

It should be noted that all actions to acquire signals, information, or data in the present disclosure are performed on the premise of complying with corresponding data protection laws and policies of a country where a device is located, and on the premise of obtaining authorization from an owner of the corresponding device.

Although operations are described in the accompanying drawings in particular orders in the embodiments of the present disclosure, it should not be understood that these operations are required to be performed in the shown particular orders or in serial orders, or that all illustrated operations are required to be performed to achieve expected results. In particular environments, multitasking and parallel processing may be advantageous. In addition, it is advantageous to send a plurality of pieces of information via a same message.

A carrier component (CC) divides a frequency domain into a plurality of subbands (SB) on a downlink (DL) symbol or a flexible (F) symbol. The plurality of SBs include one UL subband and at least one DL subband. A base station can send a DL signal on the DL subband and receive a UL signal on the UL subband at the same time.

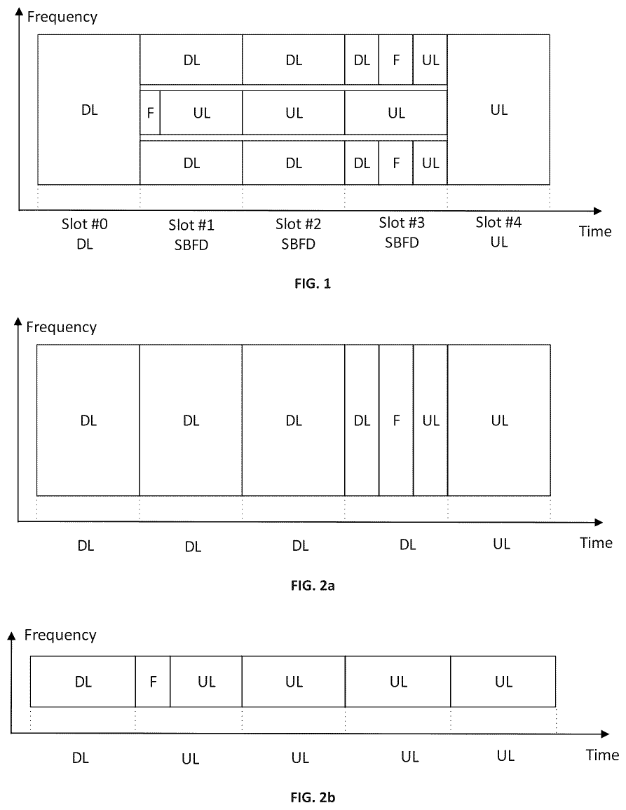

The DL symbol or the F symbol may be configured according to a time division duplexing (TDD)-UL-DL-ConfigCommon signaling or a TDD-UL-DL-ConfigDedicated signaling, or indicated according to a downlink control information (DCI) 2-0 signaling. A symbol including a DL subband and a UL subband in a frequency domain can be referred to as an SBFD symbol. Similarly, in a case where a plurality of symbols included in a slot include at least one SBFD-type symbol, the slot can be referred to as an SBFD slot. As shown in FIG. 1, slot #0 is a DL slot, slots #1-3 are SBFD slots, and slot #4 is a UL slot. Optionally, in a case where all symbols included in a slot are SBFD-type symbols, the slot can be referred to as an SBFD slot.

In some examples, a guard band (GB) may exist between the DL subband and the UL subband, and can reduce interference between the DL signal in the DL subband and the UL signal in the UL subband.

The UL subband may be configured for DL transmission. For example, in a case where a usage rate of the UL subband is low, the usage rate of the UL subband can be increased. For example, the UL subband is used for DL transmission to improve spectral efficiency of the system.

If a default UL subband (and the guard band) cannot be configured for DL transmission, it is required to explicitly or implicitly indicate that the UL subband (and the guard band) are configured for DL transmission.

In some implementations, a time frequency range of the UL subband may be dynamically indicated/semi-statically modified. That is, a frequency domain for DL transmission can be flexibly changed, to improve spectral efficiency. A collision processing criterion for a symbol direction and a signal transmission direction cannot be complicated.

However, no solution for improving a utilization rate of the UL subband (and the guard band) exists currently.

In view of this, the present disclosure provides a method and system for configuring a resource, a device, a communication device, and a storage medium to improve the utilization rate of the UL subband (and the guard band).

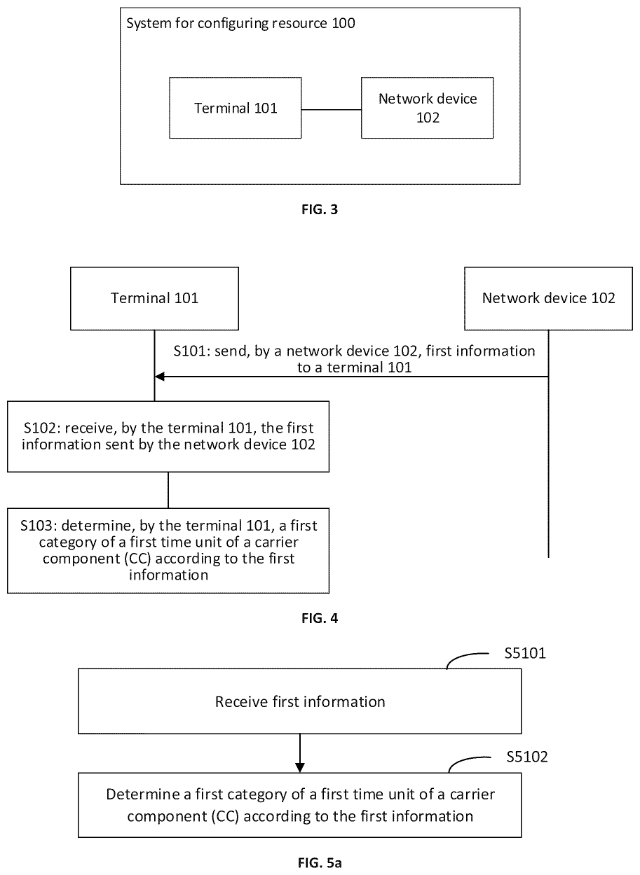

FIG. 3 is a schematic structural diagram of a system 100 for configuring a resource according to an embodiment of the present disclosure.

As shown in FIG. 3, the system 100 for configuring a resource includes a terminal 101 and a network device 102.

In some embodiments, the terminal 101 is, for example, at least one of a terminal, user equipment (UE), a subscriber unit, a mobile station, a station, a mobile phone, a wearable device, an internet of things device, a car having a communication function, a smart car, a pad, a computer having a wireless transceiver function, a virtual reality (VR) terminal device, an augmented reality (AR) terminal device, a wireless terminal device in industrial control, a wireless terminal device in self-driving, a wireless terminal device in remote medical surgery, a wireless terminal device in a smart grid, a wireless terminal device in transportation safety, a wireless terminal device in a smart city, or a wireless terminal device in a smart home, but is not restrictive.

In some embodiments, the network device 102 may include at least one of an access network device or a core network device. Optionally, the access network device is, for example, a node or device that accesses the terminal to a wireless network, such as a radio access network (RAN). The access network device may include at least one of an evolved node B (eNB) in a 5G communication system, a next generation eNB (ng-eNB), a next generation node B (gNB), a node B (NB), a home node B (HNB), a home evolved node B (HeNB), a wireless backhaul device, a radio network controller (RNC), a base station controller (BSC), a base transceiver station (BTS), a base band unit (BBU), a mobile switching center, a base station in a 6G communication system, an open RAN, a cloud RAN, a base station in another communication system, or an access node in a wireless fidelity (WiFi) system, but is not restrictive. Optionally, the network device in an embodiment of the present disclosure may include at least one of the following base stations in various forms, such as a macro base station, a micro base station (alternatively referred to as a small base station), a relay station, an access point, a 5G base station or a future base station, a satellite, a transmitting and receiving point (TRP), a transmitting point (TP), a mobile switching center, device-to-device (D2D), machine-to-machine (M2M), an internet of things (IoT), vehicle-to-everything (V2X), or another device undertaking a function of a base station in a communication system. This is not specifically limited to an embodiment of the present disclosure. For convenience of description, in all embodiments of the present disclosure, devices for providing wireless communication functions for terminal devices are collectively referred to as network devices or base stations.

In some embodiments, the technical solution of the present disclosure may be suitable for an open RAN architecture. In this case, interfaces between or in access network devices involved in an embodiment of the present disclosure may be changed to internal interfaces of the open RAN. Flows and information interaction between these internal interfaces may be implemented via software or programs.

In some embodiments, the access network device may be composed of a central unit (CU) and a distributed unit (DU). The CU may alternatively be referred to as a control unit. By using the CU-DU structure, protocol layers of the access network device can be split. Functions of some protocol layers are centralizedly controlled in the CU, and functions of some or all of the remaining protocol layers are distributed in the DU. The DU is centralizedly controlled by the CU. But this is not restrictive.

In some implementations, the core network device may be one device, which includes one or more network elements, or may be a plurality of devices or a device group, which include/includes all or some of the one or more network elements. The network element may be virtual or physical. The core network includes, for example, at least one of an evolved packet core (EPC), a 5G core network (5GCN), or a next generation core (NGC), but is not restrictive.

It can be understood that the system for configuring a resource described in the embodiments of the present disclosure is configured to more clearly explain the technical solutions of the embodiments of the present disclosure, and does not constitute limitations on the technical solutions provided in the embodiments of the present disclosure. A person of ordinary skill in the art can know that as system architectures evolve and new service scenarios appear, the technical solutions provided in the embodiments of the present disclosure are also suitable for similar technical problems.

The following embodiments of the present disclosure may be applied to the system 100 for configuring a resource shown in FIG. 3, or a part of the main body, but are not restrictive. Main bodies shown in FIG. 3 are examples. The system for configuring a resource may include all or some of the main bodies shown in FIG. 3, or may include a main body other than those shown in FIG. 3. A number of the main body is any number. A connection relationship among the main bodies is an example. A connection may be any connection, may be a direct connection or an indirect connection, or a wired connection or a wireless connection. In addition, names of the system for configuring a resource and the main bodies are not limited.

Illustratively, in some implementations, the system for configuring a resource includes a terminal and a base station.

The embodiments of the present disclosure may be applied to long term evolution (LTE), LTE-advanced (LTE-A), LTE-beyond (LTE-B), SUPER 3G, IMT-advanced, a 4th generation mobile communication system (4G), a 5th generation mobile communication system (5G), 5G new radio (NR), future radio access (FRA), a new-radio access technology (RAT), new radio (NR), new radio access (NX), future generation radio access (FX), a global system for mobile communications (GSM (registered trademark)), CDMA2000, a ultra mobile broadband (UMB), IEEE 802.11 (Wi-Fi (registered trademark)), IEEE 802.16 (WiMAX (registered trademark)), IEEE 802.20, a ultra-wideband (UWB), Bluetooth (registered trademark), a public land mobile network (PLMN), a device-to-device (D2D) system, a machine-to-machine (M2M) system, an internet of things (IoT) system, a vehicle-to-everything (V2X) system, a system using another communication method, a next-generation system expanded based on the foregoing, etc. In addition, a plurality of systems may be combined (such as a combination of LTE or LTE-A and NR) for application.

FIG. 4 is an interactive schematic diagram of a method for configuring a resource according to an embodiment of the present disclosure. As shown in FIG. 4, an embodiment of the present disclosure relates to a method for configuring a resource. The above method for configuring a resource is configured for a system 100 for configuring a resource and includes the following steps S101 to S103:

In step S101, a network device 102 sends first information to a terminal 101.

In some embodiments, the first information is, for example, downlink control information (DCI), media access control (MAC) layer control element information, and system information block 1 (SIB1) information. The DCI information may be a DCI signaling in any type/format, such as a DCI format 1-1 signaling and a DCI format 2-0 signaling.

In some embodiments, the first information is configured to indicate a first category of a first time unit of a carrier component (CC). A name of the first information is not limited.

Optionally, the first category is one of a subband full duplex (SBFD) category, a downlink (DL) category, an uplink (UL) category, or a flexible (F) category.

In some embodiments, the first time unit is a symbol unit. Optionally, the first time unit characterizes one or more symbols.

In some embodiments, the first time unit is a slot unit. Optionally, the first time unit characterizes one or more slots.

In some embodiments, the network device 102 generates or configures the first information, and the network device 102 sends the first information to the terminal 101.

As can be seen, the first category of the first time unit of the carrier component (CC) can be dynamically indicated according to the first information. Spectral efficiency of the system can be improved by dynamically indicating the first category of the carrier component (CC).

In step S102, the terminal 101 receives the first information sent by the network device 102.

In step S103, the terminal 101 determines a first category of a first time unit of a carrier component (CC) according to the first information.

Optionally, the first category is one of a subband full duplex (SBFD) category, a downlink (DL) category, an uplink (UL) category, or a flexible (F) category.

In some embodiments, a frequency domain of the carrier component (CC) includes an uplink (UL) subband and a downlink (DL) subband. For example, a frequency domain of the carrier component (CC) in FIG. 1 includes two DL subbands and one UL subband.

In some embodiments, the terminal 101 may have a second time domain resource configuration. The step that the terminal determines the first category of the first time unit of the carrier component (CC) according to the first information may include:

determining a second category of a UL subband in the first time unit according to the first information; and determining the first category according to the second category and a third category. The third category is a category of a DL subband, which is determined based on the second time domain resource configuration, in the first time unit.

The second time domain resource configuration on the terminal 101 may be configured according to a signaling sent by the network device 102 when the terminal 101 is connected to a network first time, or may be manually configured to the terminal 101 before the terminal 101 leaves a factory. This is not specifically limited in the present disclosure.

In addition, the second time domain resource configuration may alternatively be determined according to the first information. For example, the first information may include the second time domain resource configuration. Thus, the third category of the DL subband in the first time unit may be determined according to the second time domain resource configuration in the first information.

Then, in other embodiments, the step that the terminal determines the first category of the first time unit of the carrier component (CC) according to the first information may include:

determining a second category of the UL subband in the first time unit according to the first information; determining a third category of the DL subband in the first time unit according to the first information; and determining the first category according to the second category and the third category.

Optionally, the second category is one of the DL category, the UL category, or the F category. Optionally, the third category is one of the DL category, the UL category, or the F category.

How to determine the third category according to the second time domain resource configuration indicated by the first information is illustrated below with examples.

In some embodiments, the first information may include the second time domain resource configuration. Determining the third category of the DL subband in the first time unit according to the first information may include:

determining the third category according to the second time domain resource configuration.

For example, assuming that the second time domain resource configuration is the UL category, the third category is the UL category.

For example, assuming that the second time domain resource configuration is the DL category, the third category is the DL category.

For example, assuming that the second time domain resource configuration is the F category, the third category is the F category.

In some implementations, the second time domain resource configuration may characterize the third category of the DL subband in the first time unit.

As can be seen, the third category of the DL subband in the first time unit is dynamically indicated according to the first information. In this way, spectral efficiency of the system can be improved.

How to determine the first category according to the second category and the third category is illustrated below with examples.

In some embodiments, determining the first category according to the second category and the third category may include:

determining the first category as the SBFD category in a case where it is determined that the second category is different from the third category.

Illustratively, with reference to FIG. 1, assuming that the first time unit is slot #2, the second category on slot #2 is the UL category, and the third category on slot #2 is the DL category. In this case, the second category is different from the third category, and it can be determined that the first category is the SBFD category.

As can be seen, it is dynamically indicated that the second category is different from the third category according to the first information, and thus the first category of the carrier component (CC) is indicated as the SBFD category. This achieves an objective of dynamically indicating that the terminal uses an SBFD mode.

Optionally, determining the first category according to the second category and the third category may include:

determining, in a case where the second category is a same as the third category, the first category according to the second category/the third category.

As can be seen, it is dynamically indicated that the second category is a same as the third category according to the first information, and thus the first category of the carrier component (CC) can be indicated as the DL category, the UL category, or the F category. In a case where the first category of the carrier component (CC) is the DL category, the UL category, or the F category, it indicates that the terminal is in a time division duplexing (TDD) mode in the first time unit. This achieves an objective of dynamically indicating that the terminal uses the TDD mode. By indicating that the terminal is switched between the TDD mode and the SBFD mode, spectral efficiency of the system can be improved.

Illustratively, in a case where the second category and the third category are determined as DL categories, a first category is determined as the DL category.

Illustratively, in a case where the second category and the third category are UL categories, the first category is determined as the UL category.

Illustratively, in a case where the second category and the third category are flexible (F) categories, the first category is determined as the F category.

As can be seen, it is specified that in a case where the second category is a same as the third category, the first category of the carrier component (CC) is determined as the DL category, the UL category, or the F category according to a specific second category and a specific third category.

In a case where the first category is the DL category, the UL category, or the F category, it characterizes that the terminal 101 is in a time division duplexing (TDD) mode in the first time unit. In a case where the first category is the SBFD category, it characterizes that the terminal 101 is in a subband full duplex mode in the first time unit.

Optionally, the second time range includes a plurality of time units. In a case where at least one time unit of all time units in the second time range is the SBFD category, the network device and the terminal device may be referred to as being in the SBFD modes. In a case where all time units are the DL categories, the UL categories, or the F categories (non-SBFD categories), the network device and the terminal device may be referred to as being in the TDD modes. The second time range may be a time range having any length.

As can be seen, the first category of the first time unit of the carrier component (CC) is indicated according to the first information. In this way, spectral efficiency of the system can be improved.

How to determine the second category according to the first time domain resource configuration indicated by the first information is illustrated below with examples.

In some embodiments, the terminal 101 has a plurality of resource configurations. Optionally, the plurality of resource configurations are configured according to second information sent by the network device 102. Each resource configuration corresponds to one index.

As can be seen, it is specified that the plurality of resource configurations on the terminal can be configured according to information other than the first information, such as the second information.

Optionally, the second information may be a radio resource control (RRC) signaling.

In some embodiments, the first information includes a first field. Determining the second category of the UL subband in the first time unit according to the first information may include:

determining a first resource configuration from the plurality of resource configurations according to the first field, where the first resource configuration includes a first time domain resource configuration; and determining the second category according to the first time domain resource configuration.

Optionally, a value of the first field is an index value. In some embodiments, the index value may be in a bitmap form.

Illustratively, according to the first field, a first resource configuration corresponding to the index value of the first field may be determined from the plurality of resource configurations. The second category can be determined according to the first time domain resource configuration in the first resource configuration.

For example, assuming that the first time domain resource configuration is the UL category, the second category is the UL category.

For example, assuming that the first time domain resource configuration is the DL category, the second category is the DL category.

For example, assuming that the first time domain resource configuration is the F category, the second category is the F category.

In some embodiments, in a case where the first time domain resource configuration is null, it is determined that the second category is a same as the third category.

In some embodiments, the first time domain resource configuration characterizes the second category of the UL subband in the first time unit.

As can be seen, by setting a function of the first field of the first information to be used for determining the second category of the UL subband in the first time unit, an objective of determining the second category according to the first field of the first information can be achieved. This method is simple and easy to implement.

In some embodiments, the terminal 101 has one resource configuration. The resource configuration includes a first time domain resource configuration. Optionally, the resource configuration is configured according to third information sent by the network device 102. Optionally, the third information may be an RRC signaling.

In some embodiments, the first information includes a second field. Determining the second category of the UL subband in the first time unit according to the first information may include:

determining, in a case where a value of the second field is determined as a first value, the second category according to the first time domain resource configuration; and determining, in a case where the value of the second field is determined as the second value or the second field is determined as null, the second category according to a third category.

Optionally, the second field may be a newly added field, a redundant field, or a reserved field in the first information, such as DCI information, MAC control element (MAC CE) information, and system information block (SIB)1 information. This is not limited in the present disclosure.

A length of the second field may be 1 bit. The first value may be 0, and the second value may be 1. Or, the first value may be 1, and the second value may be 0.

Illustratively, in a case where the value of the second field is determined as 1, the second category is determined according to the first time domain resource configuration. For example, assuming that the first time domain resource configuration is the UL category, it can be determined that the second category is the UL category. For example, assuming that the first time domain resource configuration is the DL category, it can be determined that the second category is the DL category. For example, assuming that the first time domain resource configuration is the F category, it can be determined that the second category is the F category.

Illustratively, in a case where the value of the second field is determined as 0 or the second field is determined as null, the second category is determined according to the third category. For example, it is determined that the second category is a same as the third category.

As can be seen, by setting a function of the second field of the first information to be used for determining the second category, an objective of determining the second category according to the second field of the first information can be achieved. This method is simple and easy to implement.

It should be noted that in a case where it is determined that the second category is a same as the third category, it characterizes that the terminal 101 uses the time division duplexing mode.

As can be seen, the second category of the UL subband in the first time unit is dynamically indicated according to the first information. If the second category of the UL subband in the first time unit is indicated as the DL category, a utilization rate of the UL subband can be improved, and spectral efficiency of the system can be improved.

In some embodiments, in a case where both the second category and the third category are the DL categories, a guard band (GB) between the UL subband and the DL subband can also be configured for DL transmission.

How to determine at least one of the second category or the third category according to the first information is illustrated below with examples.

In some embodiments, the first information may include a third field and a downlink control information format 2-0 (DCI format 2-0) signaling. Determining the second category of the UL subband in the first time unit according to the first information may include:

determining, in a case where the value of the third field is determined as the first value, the second category according to the DCI format 2-0 signaling.

Optionally, the third field may be a newly added field, a redundant field, or a reserved field in the first information, such as DCI information, MAC CE information, and SIB1 information. This is not limited in the present disclosure.

A length of the third field may be 1 bit. The first value may be 0, and the second value may be 1. Or, the first value may be 1, and the second value may be 0.

Optionally, the DCI format 2-0 signaling indicates the category of the first symbol. For example, a serdes framer interface (SFI) field in the DCI format 2-0 signaling indicates a category of one or more symbols. The one or more symbols include the first symbol.

Illustratively, assuming that the DCI format 2-0 signaling indicates that the category of the first symbol is the DL category, in a case where the value of the third field is determined as the first value, the second category of the first symbol is determined as the DL category.

Illustratively, assuming that the DCI format 2-0 signaling indicates that the category of the first symbol is the UL category, in a case where the value of the third field is determined as the first value, the second category of the first symbol is determined as the UL category.

Illustratively, assuming that the DCI format 2-0 signaling indicates that the category of the first symbol is the F category, in a case where the value of the third field is determined as the first value, the second category of the first symbol is determined as the F category.

In some embodiments, in a case where the third field is determined as the second value, the third category can be determined according to the DCI format 2-0 signaling.

Illustratively, assuming that the DCI format 2-0 signaling indicates that the category of the first symbol is the DL category, in a case where the third field is determined as the second value, the third category of the first symbol is determined as the DL category.

Illustratively, assuming that the DCI format 2-0 signaling indicates that the category of the first symbol is the UL category, in a case where the third field is determined as the second value, the third category of the first symbol is determined as the UL category.

Illustratively, assuming that the DCI format 2-0 signaling indicates that the category of the first symbol is the F category, in a case where the third field is determined as the second value, the third category of the first symbol is determined as the F category.

As can be seen, a beneficial technical effect of dynamically configuring the second category of the UL subband in the first time unit or dynamically configuring the third category of the DL subband in the first time unit can be achieved according to the third field in the first information and the DCI format 2-0 signaling.

In some embodiments, the first information includes the DCI format 2-0 signaling. Determining the second category of the UL subband in the first time unit according to the first information may include: determining the second category according to the DCI format 2-0 signaling. Moreover, the step that the third category of the DL subband in the first time unit is determined according to the first information may include: determining the third category according to the DCI format 2-0 signaling.

As can be seen, it is specified that the second category of the UL subband in the first time unit and the third category of the DL subband in the first time unit can be determined at the same time according to the DCI format 2-0 signaling in the first information.

Optionally, the DCI format 2-0 signaling indicates a plurality of symbol categories. For example, the SFI field in the DCI format 2-0 signaling indicates a plurality of symbol categories.

In some embodiments, a number of first time units is M. The method for configuring a resource includes: determining categories of 2M time units according to the DCI format 2-0 signaling. Specifically, M is an integer greater than 0.

Optionally, determining the second category according to the DCI format 2-0 signaling may include: determining second categories of M time units according to categories of odd time units of the categories of the 2M time units. Determining the third category according to the DCI format 2-0 signaling may include: determining the third categories of the M time units according to categories of even time units of the categories of the 2M time units.

Illustratively, as shown in Table 1, categories of a 1st time unit, a 3rd time unit, a 5th time unit, a 7th time unit, and a 9th time unit of categories of ten time units can be determined as second categories of five time units. The obtained second categories of the five time units are a DL category, a DL category, a DL category, a DL category, and a UL category in sequence. A 2nd category, a 4th category, a 6th category, an 8th category, and a 10th category of categories of the ten time units can be determined as third categories of the 5 time units. The obtained third categories of the five time units are a DL category, a UL category, a UL category, a UL category, and a UL category in sequence.

TABLE 1

| | 1 | 2 | 3 | 4 | 5 | 6 | 7 | 8 | 9 | 10 |
|---|---|---|---|---|---|---|---|---|---|---|
| Content indicated by SFI | DL | DL | DL | UL | DL | UL | DL | UL | UL | UL |
| Second category | 1 | | 1 | | 1 | | 1 | | 1 | |
| Third category | | 1 | | 1 | | 1 | | 1 | | 1 |

As can be seen, it is specified that in a case where the categories of the 2M time units are determined according to the DCI format 2-0 signaling in the first information, M second categories can be determined according to the categories of the odd time units of the categories of the 2M time units, and M third categories can be determined according to the categories of the even time units of the categories of the 2M time units.

Optionally, the step that the second category is determined according to the DCI format 2-0 signaling may include: determining second categories of M time units according to categories of even time units of the categories of the 2M time units. The step that the third category is determined according to the DCI format 2-0 signaling may include: determining the third categories of the M time units according to categories of odd time units of the categories of the 2M time units.

Illustratively, as shown in Table 2, a 2nd category, a 4th category, a 6th category, an 8th category, and a 10th category of categories of the ten time units can be determined as second categories of the five time units. The obtained second categories of the five time units are a DL category, a UL category, a UL category, a UL category, and a UL category in sequence. A 1st category, a 3rd category, a 5th category, a 7th category, and a 9th category of the categories of the ten time units can be determined as third categories of the five time units. The obtained third categories of the five time units are a DL category, a DL category, a DL category, a DL category, and a UL category in sequence.

TABLE 2

| | 1 | 2 | 3 | 4 | 5 | 6 | 7 | 8 | 9 | 10 |
|---|---|---|---|---|---|---|---|---|---|---|
| Content indicated by SFI | DL | DL | DL | UL | DL | UL | DL | UL | UL | UL |
| Second category | | 1 | | 1 | | 1 | | 1 | | 1 |
| Third category | 1 | | 1 | | 1 | | 1 | | 1 | |

As can be seen, it is specified that in a case where the categories of the 2M time units are determined according to the DCI format 2-0 signaling in the first information, M second categories can be determined according to the categories of the odd time units of the categories of the 2M time units, and M third categories can be determined according to the categories of the even time units of the categories of the 2M time units.

The second category of the UL subband in the first time unit and the third category of the DL subband in the first time unit are indicated according to the first information. In this way, spectral efficiency of the system can be improved.

How to determine the first category according to the first information is illustrated below with examples.

In some embodiments, the first information includes a fourth field and a fifth field. The fourth field indicates a first time range. The first time range includes a first time unit of which a category is the SBFD category. The step that the first category of the first time unit of the carrier component (CC) is determined according to the first information may include:

determining, according to the fifth field, whether to modify the category of the first time unit, and determining the first category of the first time unit. Optionally, it is determined, according to the fifth field, to modify the category of the first time unit, and a modified first category is obtained. Optionally, it is determined, according to the fifth field, not to modify the category of the first time unit, and it is determined that the first category is kept as the SBFD category.

As can be seen, it is specified that whether to modify the category of the first time unit is determined according to the first information. Since whether to modify the category of the first time unit can be determined according to the first information, spectral efficiency of the system can be improved.

In some embodiments, the first information is the DCI signaling. The fifth field is a newly added field, a redundant field, or a reserved field in the DCI signaling. This is not limited in the present disclosure.

A length of the fifth field may be 1 bit.

Optionally, the step that it is determined, according to the fifth field, to modify the category of the first time unit, and an first category is obtained may include: determining, in a case where the value of the fifth field is determined as the first value, to modify the category of the first time unit, and modifying the category of the first time unit to the DL category.

Optionally, the step that it is determined, according to the fifth field, not to modify the category of the first time unit, and it is determined that the first category is the SBFD category may include: determining, in a case where the value of the fifth field is determined as the second value or the fifth field is determined as null, not to modify the category of the first time unit, and obtaining the first category of the first time unit as the SBFD category.

The first value may be 0, and the second value may be 1. Or, the first value may be 1, and the second value may be 0.

As can be seen, by setting a function of the newly added field or the redundant field in the DCI signaling to be used for determining whether to modify the category of the first time unit, an objective of determining whether to modify the category of the first time unit according to the newly added field or the redundant field in the DCI signaling can be achieved.

Optionally, the DCI signaling is specifically a DCI format 1-1 signaling. The fifth field may be configured to indicate whether the reserved resource is activated. The reserved resource is the category of the first time unit.

Illustratively, the first time unit is the SBFD category, and a time frequency resource of the UL subband in the first time unit is configured as the reserved resource. In this way, the step that it is determined, according to the fifth field, to modify the category of the first time unit, and an first category is obtained may include: determining, in a case where the value of the fifth field in the DCI format 1-1 signaling is the first value, that the reserved resource is not activated. The reserved resource being not activated characterizes that the category of the first time unit is modified such that the category of the first time unit can be modified to the DL category.

Illustratively, the first time unit is the SBFD category, and a time frequency resource of the UL subband in the first time unit is configured as the reserved resource. In this way, the step that the category of the first time unit is determined, according to the fifth field, to be not modified, and that the first category is determined as the SBFD category may include: determining, in a case where the value of the fifth field in the DCI format 1-1 signaling is the second value, that the reserved resource is activated. The reserved resource being activated characterizes that the category of the first time unit is not modified such that the first category of the first time unit can be obtained as the SBFD category.

As can be seen, the category of the first time unit is configured as a reserved resource. In this way, whether to modify the category of the first time unit can be determined by determining whether the reserved resource is activated.

In some implementations, the first information includes frequency domain allocation of a DCI indication type 0 physical downlink shared channel (type 0 PDSCH). The fifth field is a frequency domain resource allocation (FDRA) field. The step that it is determined, according to the fifth field, to modify the category of the first time unit, and an first category is obtained may include: determining the first resource block group (RBG) set according to the fifth field. If the first RBG set includes a first RBG, a frequency domain of the first RBG does not overlap with the DL subband. The category of the first time unit is modified to the DL category.

As can be seen, it is specified that whether to modify the category of the first time unit to the DL category is determined according to type 0 frequency domain allocation.

Correspondingly, in a case where the first RBG set include no first RBG, it is determined that the category of the first time unit is not modified, and the first category of the first time unit is obtained as the SBFD category.

The frequency domain of the first RBG does not overlap with the DL subband. It can be understood as follows: a physical resource block (PRB) included in the first RBG is not a PRB included in the frequency domain of the DL subband.

It should be noted that a resource location indicated by type 0 may be continuous or flexibly dispersed according to a channel requirement.

In some implementations, the first information includes DCI indication type 1 frequency domain allocation (type 1 physical downlink shared channel (PDSCH)). The fifth field includes a first frequency domain resource allocation field and a second frequency domain resource allocation field. The step that it is determined, according to the fifth field, to modify the category of the first time unit, and a first category is obtained may include: determining the first frequency domain resource according to the first frequency domain resource allocation field and the second frequency domain resource allocation field. If the first frequency domain resource is discontinuous and includes a first physical resource block (PRB), a frequency domain of the first PRB does not overlap with the DL subband. The category of the first time unit is modified to the DL category.

As can be seen, it is specified that whether to modify the category of the first time unit to the DL category is determined according to type 1 frequency domain allocation.

Optionally, determining the first frequency domain resource according to the first frequency domain resource allocation field and the second frequency domain resource allocation field may include: determining a second frequency domain resource according to the first frequency domain resource allocation field; determining a third frequency domain resource according to the second frequency domain resource allocation field; and determining a union set of the second frequency domain resource and the third frequency domain resource as the first frequency domain resource.

It should be noted that a resource location indicated by type 1 is contiguous. Thus, the second frequency domain resource characterizes a segment of continuous PRBs, and the third frequency domain resource characterizes a segment of continuous PRBs.

Illustratively, the second frequency domain resource is determined according to the first frequency domain resource allocation field; the third frequency domain resource is determined according to the second frequency domain resource allocation field; and the union set of the second frequency domain resource and the third frequency domain resource characterizes the first frequency domain resource. If the segment of continuous PRBs characterized by the second frequency domain resource are spaced apart from the segment of continuous PRBs characterized by the third frequency domain resource by at least one PRB, it characterizes that the first frequency domain resource is discontinuous. If the first frequency domain resource is discontinuous and the first frequency domain resource includes a first physical resource block (PRB), a frequency domain of the first PRB does not overlap with the DL subband, and the category of the first time unit is modified to the DL category.

The frequency domain of the first PRB does not overlap with the DL subband. It can be understood that the first PRB is not a PRB included in the frequency domain of the DL subband.

Assuming that the segment of continuous PRBs characterized by the second frequency domain resource are PRB1, PRB2, and PRB3, and the segment of continuous PRBs characterized by the third frequency domain resource are PRB7, PRB8, and PRB9, since PRB1, PRB2, and PRB3 are spaced apart from PRB7, PRB8, and PRB9 by PRB4, PRB5, and PRB6, the first frequency domain resource PRB1, PRB2, PRB3, PRB7, PRB8, and PRB9 are discontinuous.

As can be seen, the method for determining the first frequency domain resource is specified.

Optionally, determining the first frequency domain resource according to the first frequency domain resource allocation field and the second frequency domain resource allocation field may include: determining the second frequency domain resource according to the first frequency domain resource allocation field; determining the third frequency domain resource according to the second frequency domain resource allocation field; and determining, in a case where the second frequency domain resource is determined as a proper subset of the third frequency domain resource, a complementary set of the second frequency domain resource in the third frequency domain resource as the first frequency domain resource.

As can be seen, the method for determining the first frequency domain resource is specified.

Illustratively, the second frequency domain resource is determined according to the first frequency domain resource allocation field; the third frequency domain resource is determined according to the second frequency domain resource allocation field; and in a case where the second frequency domain resource is determined as a proper subset of the third frequency domain resource, a complementary set of the second frequency domain resource in the third frequency domain resource is determined as the first frequency domain resource. If the first frequency domain resource is discontinuous and the first frequency domain resource includes a first physical resource block (PRB), a frequency domain of the first PRB does not overlap with the DL subband, and the category of the first time unit is modified to the DL category.

Assuming that the second frequency domain resource is PRB4, PRB5, and PRB6, and the third frequency domain resource is PRB1, PRB2, PRB3, PRB4, PRB5, PRB6, PRB7, PRB8, and PRB9, the second frequency domain resource is a proper subset of the third frequency domain resource. In this way, complementary sets PRB1, PRB2, PRB3, PRB7, PRB8, and PRB9 of the second frequency domain resource in the third frequency domain resource can be determined as the first frequency domain resources. Since PRB1, PRB2, PRB3, PRB7, PRB8, and PRB9 are discontinuous, the first frequency domain resources PRB1, PRB2, PRB3, PRB7, PRB8, and PRB9 are discontinuous.

Optionally, determining the first frequency domain resource according to the first frequency domain resource allocation field and the second frequency domain resource allocation field may include: determining the second frequency domain resource according to the first frequency domain resource allocation field; determining the third frequency domain resource according to the second frequency domain resource allocation field; and determining, in a case where the third frequency domain resource is determined as a proper subset of the second frequency domain resource, a complementary set of the third frequency domain resource in the second frequency domain resource as the first frequency domain resource.

As can be seen, the first category of the first time unit of the carrier component (CC) is indicated according to the first information. In this way, spectral efficiency of the system can be improved.

In some implementations, the terminal 101 has one or more resource configurations. Each resource configuration may further include at least one of a first frequency domain resource configuration of the UL subband, a second frequency domain resource configuration of the DL subband, or a third frequency domain resource configuration of the carrier component (CC).

Illustratively, each resource configuration includes a first frequency domain resource configuration of the UL subband. The first frequency domain resource configuration of the UL subband characterizes a frequency domain of the UL subband.

Illustratively, each resource configuration includes a second frequency domain resource configuration of the DL subband. The second frequency domain resource configuration of the DL subband characterizes a frequency domain of the DL subband.

Illustratively, each resource configuration includes a third frequency domain resource configuration of the carrier component (CC). The third frequency domain resource configuration of the carrier component (CC) characterizes the frequency domain of the carrier component (CC).

As can be seen, it is specified that the frequency domain of at least one of the UL subband, the DL subband, or the carrier component (CC) can be configured in a manner other than the first information, such as second information.

In some implementations, the method for configuring a resource further includes: determining, according to the first information, a first frequency domain resource configuration for transmitting a UL signal and a second frequency domain resource configuration for transmitting a DL signal in the first time unit.

The first information is further configured to indicate the first frequency domain resource configuration for transmitting the UL signal and the second frequency domain resource configuration for transmitting the DL signal in the first time unit.

As can be seen, the frequency domain of the UL subband and the frequency domain of the DL subband can be modified or configured according to the first information.

In some implementations, in a case where the first category of the first time unit is determined as the SBFD category, the UL signal is transmitted according to the first frequency domain resource configuration, and the DL signal is transmitted according to the second frequency domain resource configuration.

Illustratively, in a case where the first category of the first time unit is determined as the SBFD category, the UL signal is transmitted according to the first frequency domain resource configuration in the first time unit, and the DL signal is transmitted according to the second frequency domain resource configuration in the first time unit.

As can be seen, it is specified that in a case where the first category is the SBFD category, the UL signal is transmitted according to the first frequency domain resource configuration, and the DL signal is transmitted according to the second frequency domain resource configuration.

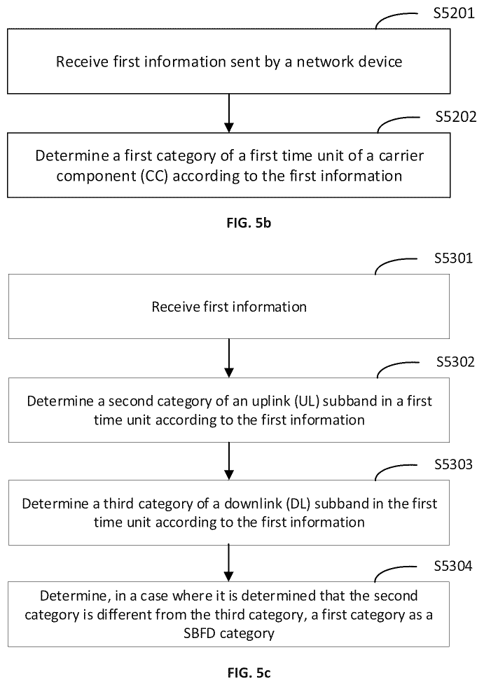

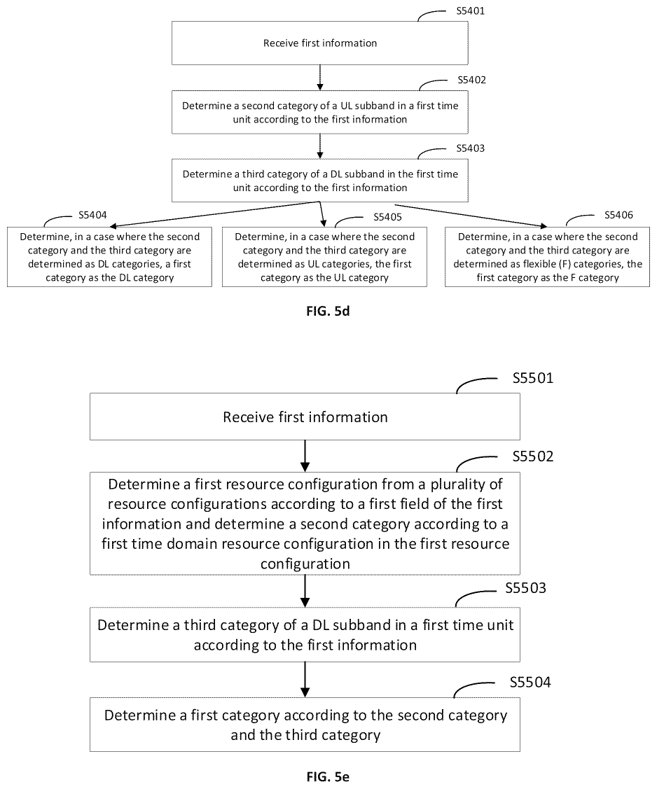

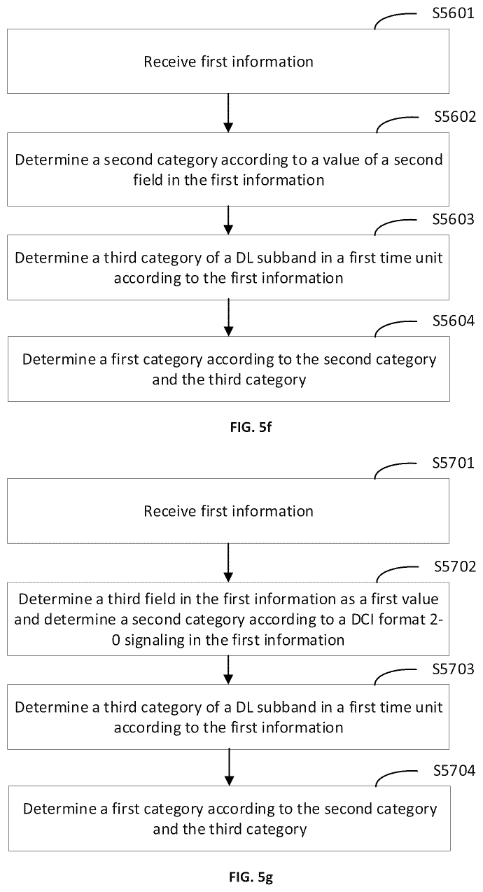

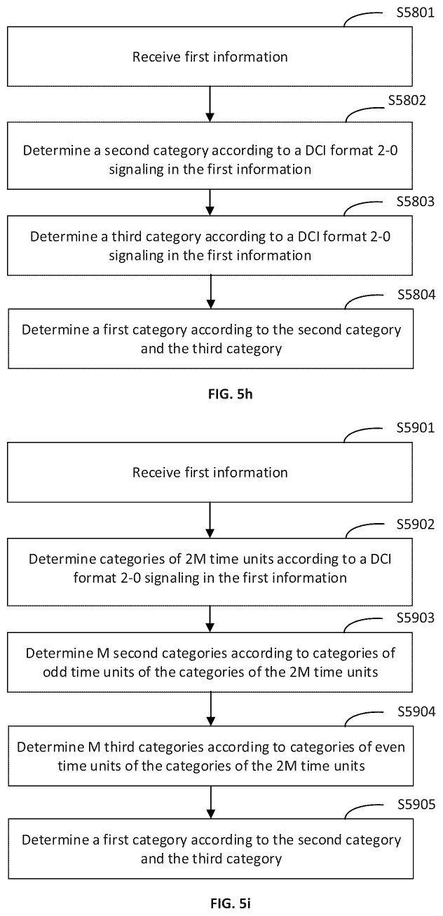

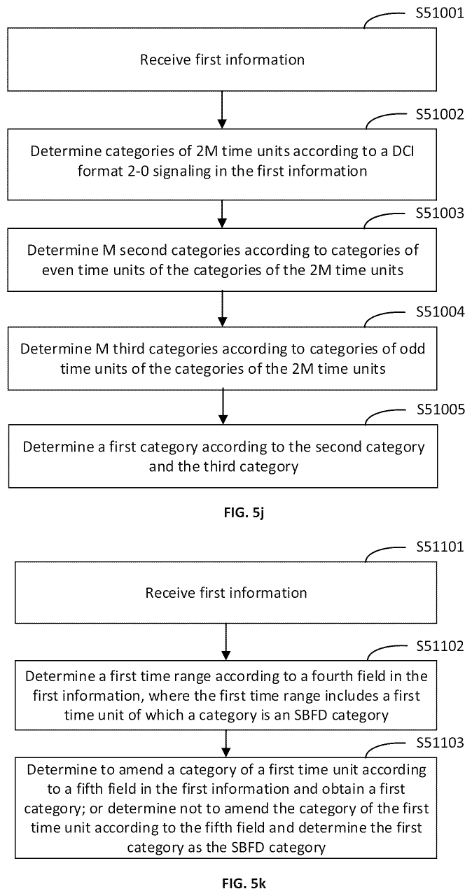

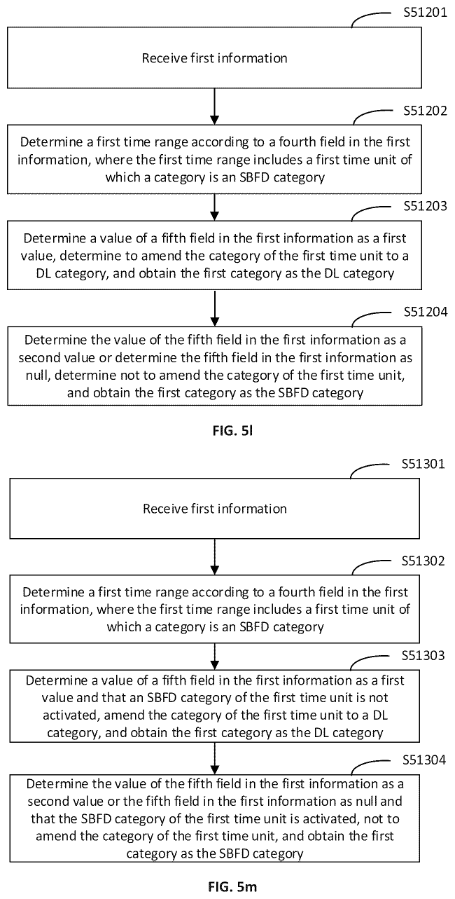

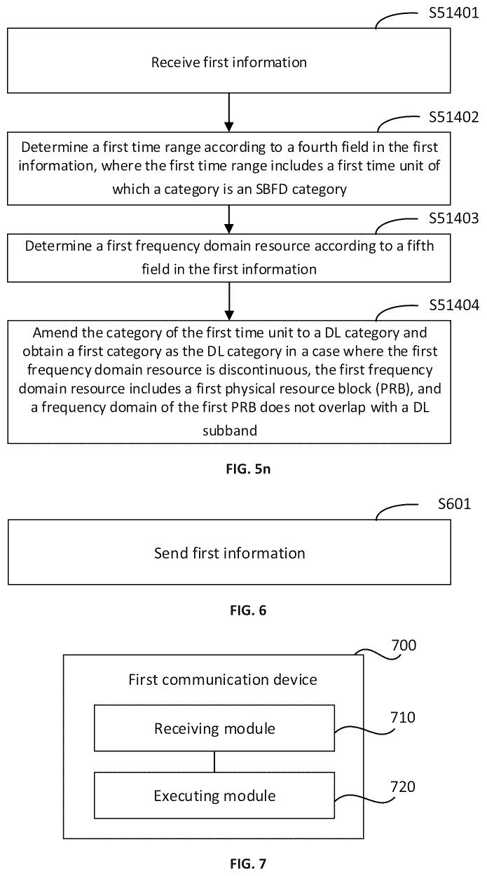

FIG. 5a is a schematic flowchart of a method for configuring a resource according to an embodiment of the present disclosure. As shown in FIG. 5a, an embodiment of the present disclosure relates to a method for configuring a resource. The above method is performed by a terminal 101 and includes the following steps S5101 and S5102.

In step S5101, first information is received.

An optional implementation of step S5101 can be obtained with reference to the implementation of step S102 in FIG. 4 and other related parts in the embodiment involved in FIG. 4, and is not repeated here.

Optionally, the first information is configured to indicate a first category of a first time unit of a carrier component (CC). The first category is one of a subband full duplex (SBFD) category, a downlink (DL) category, an uplink (UL) category, or a flexible (F) category.

In some implementations, the terminal 101 receives the first information sent by the network device 102, but is not restrictive, and may alternatively receive the first information sent by other main bodies.

In some embodiments, the terminal 101 acquires the first information specified by a protocol.

In some embodiments, the terminal 101 acquires the first information from an upper layer(s).

In some embodiments, the terminal 101 obtains the first information by performing processing.

In some embodiments, step S5101 is omitted. The terminal 101 autonomously implements a function indicated by the first information, or the above function is default.

In step S5102, a first category of a first time unit of a carrier component (CC) is determined according to the first information.

An optional implementation of step S5102 can be obtained with reference to the implementation of step S103 in FIG. 4 and other related parts in the embodiment involved in FIG. 4, and is not repeated here.

In some implementations, the first category of the first time unit of the carrier component (CC) is determined according to the first information.

The method for configuring a resource involved in an embodiment of the present disclosure may include at least one of step S5101 or S5102. For example, step S5102 may be implemented as an independent embodiment, but is not restrictive.

In some embodiments, step S5101 may be omitted or substituted in different embodiments.

Via the above method, the first category of the first time unit of the carrier component (CC) is determined (for example, configured, indicated, and modified) according to the first information. In this way, spectral efficiency of the system can be improved.

FIG. 5b is a schematic flowchart of a method for configuring a resource according to an embodiment of the present disclosure. As shown in FIG. 5b, an embodiment of the present disclosure relates to a method for configuring a resource. The above method is performed by a terminal 101 and includes the following steps S5201 and S5202.

In step S5201, first information sent by a network device is received.

An optional implementation of step S5201 can be obtained with reference to the implementations of step S102 in FIG. 4 and step S5101 in FIG. 5a, and other related parts in the embodiments involved in FIG. 4 and FIG. 5a, and is not repeated here.

In step S5202, a first category of a first time unit of a carrier component (CC) is determined according to the first information.

An optional implementation of step S5202 can be obtained with reference to the implementations of step S103 in FIG. 4 and step S5102 in FIG. 5a, and other related parts in the embodiments involved in FIG. 4 and FIG. 5a, and is not repeated here.

The method for configuring a resource involved in an embodiment of the present disclosure may include at least one of step S5201 or step S5202. For example, step S5202 may be implemented as an independent embodiment, but is not restrictive.

In some embodiments, step S5201 may be omitted or substituted in different embodiments.

Via the above method, the first category of the first time unit of the carrier component (CC) is determined (for example, configured, indicated, and modified) according to the first information. In this way, spectral efficiency of the system can be improved.

FIG. 5c is a schematic flowchart of a method for configuring a resource according to an embodiment of the present disclosure. As shown in FIG. 5c, an embodiment of the present disclosure relates to a method for configuring a resource. The above method is performed by a terminal 101 and includes the following steps S5301 to S5304.

In step S5301, first information is received.

An optional implementation of step S5301 can be obtained with reference to the implementations of step S102 in FIG. 4 and step S5101 in FIG. 5a, and other related parts in the embodiments involved in FIG. 4 and FIG. 5a, and is not repeated here.

In step S5302, a second category of an UL subband in a first time unit is determined according to the first information.

In step S5303, a third category of a DL subband in a first time unit is determined according to the first information.

In step S5304, in a case where it is determined that the second category is different from the third category, the first category is determined as the SBFD category.

Optional implementations of steps S5302, S5303, and S5304 can be obtained with reference to the implementations of step S103 in FIG. 4 and step S5102 in FIG. 5a, and other related parts in the embodiments involved in FIG. 4 and FIG. 5a, and are not repeated here.

The method for configuring a resource involved in an embodiment of the present disclosure may include at least one of steps S5301 to S5304. For example, step S5304 may be implemented as an independent embodiment, and steps S5301 and S5304 may be implemented as independent embodiments, which are not restrictive.

In some implementations, steps S5302 and S5303 may be performed at the same time.

In some embodiments, one or more of steps S5301 to S5304 may be omitted or substituted in different embodiments.

FIG. 5d is a schematic flowchart of a method for configuring a resource according to an embodiment of the present disclosure. As shown in FIG. 5d, an embodiment of the present disclosure relates to a method for configuring a resource. The above method is performed by a terminal 101 and includes the following steps S5401 to S5406.

In step S5401, first information is received.

An optional implementation of step S5401 can be obtained with reference to the implementations of step S102 in FIG. 4 and step S5101 in FIG. 5a, and other related parts in the embodiments involved in FIG. 4 and FIG. 5a, and is not repeated here.

In step S5402, a second category of an UL subband in a first time unit is determined according to the first information.

In step S5403, a third category of a DL subband in a first time unit is determined according to the first information.

Then, step S5404, S5405, or S5406 is performed.

In step S5404, in a case where the second category and the third category are determined as DL categories, a first category is determined as the DL category.

In step S5405, in a case where the second category and the third category are determined as UL categories, the first category is determined as the UL category.

In step S5406, in a case where the second category and the third category are determined as F categories, the first category is determined as the F category.

Optional implementations of steps S5402, S5403, S5404, S5405, and S5406 can be obtained with reference to the implementations of step S103 in FIG. 4 and step S5102 in FIG. 5a, and other related parts in the embodiments involved in FIG. 4 and FIG. 5a, and are not repeated here.

The method for configuring a resource involved in an embodiment of the present disclosure may include at least one of steps S5401 to S5406. For example, step S5404 may be implemented as an independent embodiment, step S5405 may be implemented as an independent embodiment, step S5406 may be implemented as an independent embodiment, and steps S5401 and S5405 may be implemented as independent embodiments, which are not restrictive.

In some implementations, steps S5402 and S5403 may be performed at the same time.

In some embodiments, one or more of steps S5401 to S5406 may be omitted or substituted in different embodiments.

FIG. 5e is a schematic flowchart of a method for configuring a resource according to an embodiment of the present disclosure. As shown in FIG. 5e, an embodiment of the present disclosure relates to a method for configuring a resource. The above method is performed by a terminal 101 and includes the following steps S5501 to S5504.

In step S5501, first information is received.

An optional implementation of step S5501 can be obtained with reference to the implementations of step S102 in FIG. 4 and step S5101 in FIG. 5a, and other related parts in the embodiments involved in FIG. 4 and FIG. 5a, and is not repeated here.

In step S5502, a first resource configuration is determined from a plurality of resource configurations according to a first field of the first information, and a second category is determined according to a first time domain resource configuration in the first resource configuration.

In step S5503, a third category of a DL subband in a first time unit is determined according to the first information.

In step S5504, a first category is determined according to the second category and the third category.

Optional implementations of steps S5502, S5503, and S5504 can be obtained with reference to the implementations of step S103 in FIG. 4 and step S5102 in FIG. 5a, and other related parts in the embodiments involved in FIG. 4 and FIG. 5a, and are not repeated here.

The method for configuring a resource involved in an embodiment of the present disclosure may include at least one of steps S5501 to S5504. For example, step S5504 may be implemented as an independent embodiment, and steps S5501 and S5504 may be implemented as independent embodiments, which are not restrictive.

In some implementations, steps S5502 and S5503 may be performed at the same time.

In some embodiments, one or more of steps S5501 to S5504 may be omitted or substituted in different embodiments.

FIG. 5f is a schematic flowchart of a method for configuring a resource according to an embodiment of the present disclosure. As shown in FIG. 5f, an embodiment of the present disclosure relates to a method for configuring a resource. The above method is performed by a terminal 101 and includes the following steps S5601 to S5604.

In step S5601, first information is received.

An optional implementation of step S5601 can be obtained with reference to the implementations of step S102 in FIG. 4 and step S5101 in FIG. 5a, and other related parts in the embodiments involved in FIG. 4 and FIG. 5a, and is not repeated here.

In step S5602, a second category is determined according to a value of a second field in the first information.

A value of the second field may be configured to indicate whether to determine the second category according to a first time domain resource configuration in one resource configuration on the terminal 101.

In step S5603, a third category of a DL subband in a first time unit is determined according to the first information.

In step S5604, a first category is determined according to the second category and the third category.

Optional implementations of steps S5602, S5603, and S5604 can be obtained with reference to the implementations of step S103 in FIG. 4 and step S5102 in FIG. 5a, and other related parts in the embodiments involved in FIG. 4 and FIG. 5a, and are not repeated here.

The method for configuring a resource involved in an embodiment of the present disclosure may include at least one of steps S5601 to S5604. For example, step S5604 may be implemented as an independent embodiment, and steps S5601 and S5604 may be implemented as independent embodiments, which are not restrictive.

In some implementations, steps S5602 and S5603 may be performed at the same time.

In some embodiments, one or more of steps S5601 to S5604 may be omitted or substituted in different embodiments.

FIG. 5g is a schematic flowchart of a method for configuring a resource according to an embodiment of the present disclosure. As shown in FIG. 5g, an embodiment of the present disclosure relates to a method for configuring a resource. The above method is performed by a terminal 101 and includes the following steps S5701 to S5704.

In step S5701, first information is received.

An optional implementation of step S5701 can be obtained with reference to the implementations of step S102 in FIG. 4 and step S5101 in FIG. 5a, and other related parts in the embodiments involved in FIG. 4 and FIG. 5a, and is not repeated here.

In step S5702, a value of a third field in the first information is determined as a first value, and a second category is determined according to a downlink control information format 2-0 (DCI format 2-0) signaling in the first information.

In step S5703, a third category of a DL subband in a first time unit is determined according to the first information.

In step S5704, a first category is determined according to the second category and the third category.

Optional implementations of steps S5702, S5703, and S5704 can be obtained with reference to the implementations of step S103 in FIG. 4 and step S5102 in FIG. 5a, and other related parts in the embodiments involved in FIG. 4 and FIG. 5a, and are not repeated here.

The method for configuring a resource involved in an embodiment of the present disclosure may include at least one of steps S5701 to S5704. For example, step S5704 may be implemented as an independent embodiment, and steps S5701 and S5704 may be implemented as independent embodiments, which are not restrictive.

In some implementations, steps S5702 and S5703 may be performed at the same time.

In some embodiments, one or more of steps S5701 to S5704 may be omitted or substituted in different embodiments.

FIG. 5h is a schematic flowchart of a method for configuring a resource according to an embodiment of the present disclosure. As shown in FIG. 5h, an embodiment of the present disclosure relates to a method for configuring a resource. The above method is performed by a terminal 101 and includes the following steps S5801 to S5804.

In step S5801, first information is received.

An optional implementation of step S5801 can be obtained with reference to the implementations of step S102 in FIG. 4 and step S5101 in FIG. 5a, and other related parts in the embodiments involved in FIG. 4 and FIG. 5a, and is not repeated here.

In step S5802, a second category is determined according to a DCI format 2-0 signaling in the first information.

In step S5803, a third category is determined according to a DCI format 2-0 signaling in the first information.

In step S5804, a first category is determined according to the second category and the third category.

Optional implementations of steps S5802, S5803, and S5804 can be obtained with reference to the implementations of step S103 in FIG. 4 and step S5102 in FIG. 5a, and other related parts in the embodiments involved in FIG. 4 and FIG. 5a, and are not repeated here.

The method for configuring a resource involved in an embodiment of the present disclosure may include at least one of steps S5801 to S5804. For example, step S5804 may be implemented as an independent embodiment, and steps S5801 and S5804 may be implemented as independent embodiments, which are not restrictive.

In some implementations, steps S5802 and S5803 may be performed at the same time.

In some embodiments, one or more of steps S5801 to S5804 may be omitted or substituted in different embodiments.

FIG. 5i is a schematic flowchart of a method for configuring a resource according to an embodiment of the present disclosure. As shown in FIG. 5h, an embodiment of the present disclosure relates to a method for configuring a resource. The above method is performed by a terminal 101 and includes the following steps S5901 to S5905.

In step S5901, first information is received.

An optional implementation of step S5901 can be obtained with reference to the implementations of step S102 in FIG. 4 and step S5101 in FIG. 5a, and other related parts in the embodiments involved in FIG. 4 and FIG. 5a, and is not repeated here.

In step S5902, categories of 2M time units are determined according to the DCI format 2-0 signaling in the first information.

In step S5903: M second categories are determined according to categories of odd time units of the categories of the 2M time units.

In step S5904, M third categories are determined according to categories of even time units of the categories of the 2M time units.

In step S5905, a first category is determined according to the second category and the third category.

Optional implementations of steps S5902, S5903, S5904, and S5905 can be obtained with reference to the implementations of step S103 in FIG. 4 and step S5102 in FIG. 5a, and other related parts in the embodiments involved in FIG. 4 and FIG. 5a, and are not repeated here.

The method for configuring a resource involved in an embodiment of the present disclosure may include at least one of steps S5901 to S5905. For example, step S5905 may be implemented as an independent embodiment, and steps S5901 and S5905 may be implemented as independent embodiments, which are not restrictive.

In some implementations, steps S5903 and S5904 may be performed at the same time.

In some embodiments, one or more of steps S5901 to S5905 may be omitted or substituted in different embodiments.

FIG. 5j is a schematic flowchart of a method for configuring a resource according to an embodiment of the present disclosure. As shown in FIG. 5j, an embodiment of the present disclosure relates to a method for configuring a resource. The above method is performed by a terminal 101 and includes the following steps S51001 to S51005.

In step S51001, first information is received.

An optional implementation of step S51001 can be obtained with reference to the implementations of step S102 in FIG. 4 and step S5101 in FIG. 5a, and other related parts in the embodiments involved in FIG. 4 and FIG. 5a, and is not repeated here.

In step S51002, categories of 2M time units are determined according to the DCI format 2-0 signaling in the first information.

In step S51003, M second categories are determined according to categories of even time units of the categories of the 2M time units.

In step S51004, M third categories are determined according to categories of odd time units of the categories of the 2M time units.

In step S51005, a first category is determined according to the second category and the third category.

Optional implementations of steps S51002, S51003, S51004, and S51005 can be obtained with reference to the implementations of step S103 in FIG. 4 and step S5102 in FIG. 5a, and other related parts in the embodiments involved in FIG. 4 and FIG. 5a, and are not repeated here.

The method for configuring a resource involved in an embodiment of the present disclosure may include at least one of steps S51001 to S51005. For example, step S51005 may be implemented as an independent embodiment, and steps S51001 and S51005 may be implemented as independent embodiments, which are not restrictive.

In some implementations, steps S51003 and S51004 may be performed at the same time.

In some embodiments, one or more of steps S51001 to S51005 may be omitted or substituted in different embodiments.

FIG. 5k is a schematic flowchart of a method for configuring a resource according to an embodiment of the present disclosure. As shown in FIG. 5k, an embodiment of the present disclosure relates to a method for configuring a resource. The above method is performed by a terminal 101 and includes the following steps S51101 to S51103.

In step S51101, first information is received.

An optional implementation of step S51101 can be obtained with reference to the implementations of step S102 in FIG. 4 and step S5101 in FIG. 5a, and other related parts in the embodiments involved in FIG. 4 and FIG. 5a, and is not repeated here.

In step S51102, a first time range is determined according to a fourth field in the first information, where the first time range includes a first time unit of which a category is an SBFD category.

In step S51103, it is determined according to a fifth field in the first information that a category of a first time unit is modified to obtain a first category; or it is determined according to the fifth field that the category of the first time unit is not modified, and the first category is determined as the SBFD category.

Optional implementations of steps S51102 and S51103 can be obtained with reference to the implementations of step S103 in FIG. 4 and step S5102 in FIG. 5a, and other related parts in the embodiments involved in FIG. 4 and FIG. 5a, and are not repeated here.

The method for configuring a resource involved in an embodiment of the present disclosure may include at least one of steps S51101 to S51103. For example, step S51103 may be implemented as an independent embodiment, but is not restrictive.

In some embodiments, one or more of steps S51101 to S51103 may be omitted or substituted in different embodiments.

FIG. 5l is a schematic flowchart of a method for configuring a resource according to an embodiment of the present disclosure. As shown in FIG. 5l, an embodiment of the present disclosure relates to a method for configuring a resource. The above method is performed by a terminal 101 and includes the following steps S51201 to S51204.

In step S51201, first information is received.

An optional implementation of step S51201 can be obtained with reference to the implementations of step S102 in FIG. 4 and step S5101 in FIG. 5a, and other related parts in the embodiments involved in FIG. 4 and FIG. 5a, and is not repeated here.

In step S51202, a first time range is determined according to a fourth field in the first information, where the first time range includes a first time unit of which a category is an SBFD category.

In step S51203, a value of a fifth field in the first information is determined as a first value, it is determined that the category of the first time unit is modified to a DL category, and the first category is obtained as the DL category.

In step S51204, the value of the fifth field in the first information is determined as a second value or the fifth field in the first information is determined as null, it is determined that the category of the first time unit is not modified, and the first category is obtained as the SBFD category.

Optional implementations of steps S51202, S51203, and S51204 can be obtained with reference to the implementations of step S103 in FIG. 4 and step S5102 in FIG. 5a, and other related parts in the embodiments involved in FIG. 4 and FIG. 5a, and are not repeated here.

The method for configuring a resource involved in an embodiment of the present disclosure may include at least one of steps S51201 to S51204. For example, step S51203 or S51204 may be implemented as an independent embodiment, but is not restrictive.

In some embodiments, one or more of steps S51201 to S51204 may be omitted or substituted in different embodiments.

FIG. 5m is a schematic flowchart of a method for configuring a resource according to an embodiment of the present disclosure. As shown in FIG. 5m, an embodiment of the present disclosure relates to a method for configuring a resource. The above method is performed by a terminal 101 and includes the following steps S51301 to S51304.

In step S51301, first information is received.

An optional implementation of step S51301 can be obtained with reference to the implementations of step S102 in FIG. 4 and step S5101 in FIG. 5a, and other related parts in the embodiments involved in FIG. 4 and FIG. 5a, and is not repeated here.

In step S51302, a first time range is determined according to a fourth field in the first information, where the first time range includes a first time unit of which a category is an SBFD category.

In step S51303, a value of a fifth field in the first information is determined as a first value, it is determined that an SBFD category of the first time unit is not activated, it is determined that the category of the first time unit is modified to a DL category, and the first category is obtained as the DL category.

In step S51304, the value of the fifth field in the first information is determined as a second value or the fifth field in the first information is determined as null, it is determined that the SBFD category of the first time unit is activated, it is determined that the category of the first time unit is not modified, and the first category is obtained as the SBFD category.

Optional implementations of steps S51302, S51303, and S51304 can be obtained with reference to the implementations of step S103 in FIG. 4 and step S5102 in FIG. 5a, and other related parts in the embodiments involved in FIG. 4 and FIG. 5a, and are not repeated here.

The method for configuring a resource involved in an embodiment of the present disclosure may include at least one of steps S51301 to S51304. For example, step S51303 or S51304 may be implemented as an independent embodiment, but is not restrictive.

In some embodiments, one or more of steps S51301 to S51304 may be omitted or substituted in different embodiments.

FIG. 5n is a schematic flowchart of a method for configuring a resource according to an embodiment of the present disclosure. As shown in FIG. 5n, an embodiment of the present disclosure relates to a method for configuring a resource. The above method is performed by a terminal 101 and includes the following steps S51401 to S51404.

In step S51401, first information is received.

An optional implementation of step S51401 can be obtained with reference to the implementations of step S102 in FIG. 4 and step S5101 in FIG. 5a, and other related parts in the embodiments involved in FIG. 4 and FIG. 5a, and is not repeated here.

In step S51402, a first time range is determined according to a fourth field in the first information, where the first time range includes a first time unit of which a category is an SBFD category.

In step S51403, a first frequency domain resource is determined according to a fifth field in the first information.

In step S51404, in a case where the first frequency domain resource is discontinuous, the first frequency domain resource includes a first physical resource block (PRB), and a frequency domain of the first PRB does not overlap with a DL subband, the category of the first time unit is modified to a DL category, and a first category is obtained as the DL category.

Optional implementations of steps S51402, S51403, and S51404 can be obtained with reference to the implementations of step S103 in FIG. 4 and step S5102 in FIG. 5a, and other related parts in the embodiments involved in FIG. 4 and FIG. 5a, and are not repeated here.

The method for configuring a resource involved in an embodiment of the present disclosure may include at least one of steps S51401 to S51404. For example, step S51404 may be implemented as an independent embodiment, but is not restrictive.

In some implementations, steps S51402 and S51403 may be performed at the same time.

In some embodiments, one or more of steps S51401 to S51404 may be omitted or substituted in different embodiments.

FIG. 6 is a schematic flowchart of a method for configuring a resource according to an embodiment of the present disclosure. As shown in FIG. 6, an embodiment of the present disclosure relates to a method for configuring a resource. The above method is performed by a network device 102 and includes following step S601.

In step S601, first information is sent.

An optional implementation of step S601 can be obtained with reference to the implementation of step S101 in FIG. 4 and other related parts in the embodiment involved in FIG. 4, and is not repeated here.

In some implementations, the network device 102 sends the first information to the terminal 101, but is not restrictive, and may alternatively send the first information to another main body.

In some implementations, the first information is configured to indicate a first category of a first time unit of a carrier component (CC). The first category is one of a subband full duplex (SBFD) category, a downlink (DL) category, an uplink (UL) category, or a flexible (F) category.

In some implementations, the first information is further configured to indicate a first frequency domain resource configuration for transmitting a UL signal and a second frequency domain resource configuration for transmitting a DL signal in the first time unit.

Via any one of the above methods, the first category of the first time unit of the carrier component (CC) is determined (for example, configured, indicated, and modified) according to the first information. In this way, spectral efficiency of the system can be improved.

In some embodiments, a time domain resource may be configured for the terminal via the following method for configuring a resource.

In a first implementation, at least one of a tdd-UL-DL-ConfigurationCommon signaling or a tdd-UL-DL-ConfigurationDedicated signaling are configured according to a radio resource control (RRC) signaling, to indicate a category of each slot symbol in a slot configuration period. Categories of symbols may include a DL category, a UL category and a flexible (F) category.

For example, with reference to FIG. 2a, a slot format configuration of a carrier component (CC) indicated and configured according to at least one of the tdd-UL-DL-ConfigurationCommon signaling or the tdd-UL-DL-ConfigurationDedicated signaling is shown in FIG. 2a.

For example, with reference to FIG. 2b, a category of each symbol of the UL subband in a slot configuration period, that is, a slot format configuration, which is indicated and configured according to at least one of the tdd-UL-DL-ConfigurationCommon signaling or the tdd-UL-DL-ConfigurationDedicated signaling is shown in FIG. 2b.

In combination with FIG. 2a and FIG. 2b, a slot format configuration shown in FIG. 1 can be obtained.

In a second implementation, a location of a UL symbol in the UL subband is indicated according to a bitmap or a resource indication value (RIV).

For example, assuming that granularity of 1 bit in the bitmap corresponds to 1 slot, a bitmap corresponding to FIG. 2b can be represented as 01111. Moreover, 01111 indicates that in the UL subband, a 2nd slot, a 3rd slot, a 4th slot, and a 5th slot are UL slots. It should be noted here that a number of F symbols is equal to a number of F symbols in the slot format configuration of the carrier component (CC).

For example, a starting location and duration of the UL slot/symbol in the UL subband are indicated according to the resource indication value (RIV).

In some embodiments, a frequency domain resource may be configured for the terminal via the following method for configuring a resource.

The starting location of a UL subband frequency domain and a number of persistent physical resource blocks (PRBs) are indicated according to the RIV.

In some implementations, the terminal performs following steps 1 to 4.

In step 1, one or more UL subband time frequency locations configured via RRC and sent by a base station are received.

In step 2, the one or more UL subband time frequency locations are determined according to an RRC configuration.

In step 3, DCI/MAC CE/SIB1 sent by the base station is received, where DCI/MAC CE/SIB1 indicates a UL subband time frequency resource configuration to be used.

In step 4, according to DCI/MAC CE/SIB1 and the RRC configuration, the UL subband time frequency resource configuration to be used is determined, or whether an SBFD or TDD slot format configuration is to be used is determined.

Optionally, RRC configures a plurality of UL subband time frequency resource configurations. Moreover, DCI/MAC CE/SIB1 indicates one UL subband time frequency resource configuration of the plurality of UL subband time frequency resource configurations. Each configuration corresponds to one index.

Optionally, one UL subband time frequency resource configuration is indicated according to an index or bitmap.

Optionally, in a case where an indicated UL subband time frequency resource configuration is not configured or is null, a cell is switched from a SBFD mode to a TDD mode. A CC-level slot format, configured according to at least one of an RRC cell tdd-UL-DL-ConfigurationCommon or tdd-UL-DL-ConfigurationDedicated, is used. In this case, the category of the first time unit is the DL category, the UL category, or the F category.

Optionally, the RRC configures one UL subband time frequency resource configuration, and DCI/MAC CE/SIB1 indicates whether to use the SBFD mode.

Optionally, newly added 1 bit indicates whether to use an SBFD slot format configuration. If the TDD mode is indicated to be used, the slot format, configured according to at least one of RRC cell tdd-UL-DL-ConfigurationCommon or tdd-UL-DL-ConfigurationDedicated, is used.

Optionally, a time domain configuration (that is, a format configuration of a symbol within a period) of the UL subband is modified according to DCI 2-0.

A SFI field in DCI 2-0 indicates a format of a symbol in a plurality of slots.

Optionally, a newly added 1-bit field in DCI 2-0 indicates that the DCI is configured to modify the time domain configuration of the UL subband.

In method 1, a field is 1 and indicates that the time domain configuration of the UL subband is modified, and a field is 0 and indicates that the DL subband is modified.

In method 2, in a case where a field is newly added and a value of the field is 1 or 0, the field indicates that the time domain configuration of the UL subband is modified; in a case where no field is newly added, DCI 2-0 is configured to modify the time domain configuration of the DL subband.

Optionally, in a case where an SBFD symbol exists in any period of a slot format configuration of the terminal, an SFI field in DCI 2-0 indicates a slot format of the DL subband and a slot format of the UL subband.

A first slot format of each two slot formats is configured for the DL subband, and a second slot format is configured for the UL subband. Or the first slot format of each two slot formats is configured for the UL subband, and the second slot format is configured for the DL subband.

Optionally, in a case where two DL subbands exist, slot formats of the two DL subbands are the same.

Steps performed by a base station side correspond to those performed by a terminal side, and are not repeated here.

In some implementations, the terminal performs following steps 1 and 2.

In step 1, DCI is received, and the DCI may indicate whether the UL subband can be configured for DL transmission.

In step 2, the frequency domain that can be used for DL transmission in the SBFD symbol can be determined according to the DCI.

Optionally, whether the UL subband can be configured for DL transmission is explicitly indicated. Optionally, in the DCI, a 1 bit is configured to indicate whether the UL subband can be configured for DL transmission.

Optionally, a 1-bit indication is newly added. Optionally, a redundant 1 bit is utilized, such as 1 bit of redundant bits in a frequency domain resource allocation (FDRA) field of the SBFD slot.

Optionally, a reserved resource field in DCI 1-1 indicates whether the UL subband can be configured for DL transmission.

Optionally, the time frequency resource configuration of the UL subband is rate match resource (RMR) #1. Whether RMR #1 is activated is indicated by the reserved resource field. If RMR #1 is activated, the UL subband cannot be configured for DL transmission, otherwise the UL subband can be configured for DL transmission.

Optionally, the RRC configures a subset of a time frequency resource configuration of a plurality of UL subbands as RMR #m. Whether RMR #m is activated is indicated by a reserved resource field/an extended form of the reserved resource field. If RMR #m is activated, subset RMR #m of the UL subband cannot be configured for DL transmission, otherwise subset RMR #m of the UL subband can be configured for DL transmission.

Optionally, in a case where UL subbands can be configured for DL transmission, the guard band can also be configured for DL transmission.

Optionally, whether the UL subband can be configured for DL transmission is implicitly indicated. In the FDRA of a type 0 PDSCH, one or more scheduled resource block groups (RBGs) do not include DL PRBs (only include at least one of the PRB in the guard band or the PRB in the UL subband).

Optionally, it is implicitly indicated that PRBs in RBGs that are scheduled and RBGs that overlap the UL subband (and the guard band) are all configured for DL transmission. Optionally, it is implicitly indicated that the UL subbands (and the guard band) all can be configured for DL transmission. A format of a symbol/slot in which a PDSCH is located falls back from the SBFD to the DL.

Optionally, in the FDRA of a type 1 PDSCH, the FDRA indicates a segment of continuous PRBs. In an existing method, a default UL subband (and the guard band) cannot be configured for DL transmission.

Via discontinuous scheduling, in a case where a PRB of PRBs that are discontinuously scheduled exists in the UL subband (and the guard band), it implicitly indicates that the UL subband (and the guard band) can be configured for DL transmission.

In a case of discontinuously scheduled option 1, the DCI includes two RIVs, the two RIVs indicate two continuous FDRAs respectively, PRBs between the two FDRAs are discontinuous, and a union set of the FDRAs indicated by the two RIVs is configured for DL transmission.

In a case of discontinuously scheduled option 2, the DCI includes two RIVs, RIV #1 indicates scheduled FDRA #1, RIV #2 indicates scheduled FDRA #2, and FDRA #2 is a proper subset of FDRA #1, and indicates that a resource in FDRA #1 except FDRA #2 is configured for DL transmission.

Steps performed by a base station side correspond to those performed by a terminal side, and are not repeated here.

In an embodiment of the present disclosure, some or all steps and their optional implementations may be freely combined with some or all steps in other embodiments, and may alternatively be freely combined with optional implementations in other embodiments.

An embodiment of the present disclosure further provides a device for implementing any one of the above resource configurations, for example, provides a device, where the above device includes a unit for implementing each step performed by the terminal in any one of the above methods. For another example, another device is further provided, and includes a unit configured to implement each step performed by a network device (such as an access network device, a core network functional node, and a core network device) in any one of the above methods.

It should be understood that division of the units in the above device is merely division of logical functions, and may be fully or partially integrated into a physical entity or physically separated during actual implementation. In addition, the units in the device may be implemented in the form of processor-called software. For example, the device includes a processor. The processor is connected to a memory. The memory stores computer instructions. The processor invokes the computer instructions stored in the memory, to implement any one of the above methods or to implement functions of the units of the above device. The processor is, for example, a general purpose processor, such as a central processing unit (CPU) or a microprocessor. The memory is a memory in the device or a memory outside the device. Or, the units in the device may be implemented in the form of hardware circuits. Functions of some or all of the units may be implemented by designing the hardware circuits. The above hardware circuits may be understood as one or more processors. For example, in one implementation, the above hardware circuits are application-specific integrated circuits (ASICs). By designing logic relationships of elements in the circuits, the functions of some or all of the above units are implemented. For another example, in another implementation, the hardware circuits can be implemented by programmable logic devices (PLDs). With a field programmable gate array (FPGA) as an example, the field programmable gate array may include a large number of logic gate circuits. Via configuration files, connection relationships between the logic gate circuits are configured, such that the functions of some or all of the above units are implemented. All units of the above device may be implemented entirely in the form of processor-called software, or entirely in the form of hardware circuits, or partially in the form of processor-called software, and partially in the form of hardware circuits.

In an embodiment of the present disclosure, the processor is a circuit having a signal processing capability. In an implementation, the processor may be a circuit having instruction reading and running capabilities, such as a central processing unit (CPU), a microprocessor, a graphics processing unit (GPU) (which may be understood as a microprocessor), or a digital signal processor (DSP). In another implementation, the processor may perform a function via a logical relationship of a hardware circuit. The logical relationship of the hardware circuit is fixed or reconfigurable. For example, the processor is an application-specific integrated circuit (ASIC) or a hardware circuit implemented by a programmable logic device (PLD), such as an FPGA. In a reconfigurable hardware circuit, the processor loads a configuration file to configure the hardware circuit. It can be understood as a process of loading instructions by the processor, such that the functions of some or all of the above units are implemented. In addition, the processor may be a hardware circuit designed for artificial intelligence, and can be understood as an ASIC, such as a neural network processing unit (NPU), a tensor processing unit (TPU), and a deep learning processing unit (DPU).

FIG. 7 is a schematic structural diagram of a first communication device according to an embodiment of the present disclosure. As shown in FIG. 7, the first communication device 700 includes:

a receiving module 710 configured to receive first information sent by a network device; and

an executing module 720 configured to determine a first category of a first time unit of a carrier component (CC) according to the first information, where the first category is one of a subband full duplex (SBFD) category, a downlink (DL) category, an uplink (UL) category, and a flexible (F) category.

In some implementations, a frequency domain of the carrier component (CC) includes an uplink (UL) subband and a downlink (DL) subband.

In some examples, the executing module 720 includes:
a first determining module configured to determine a second category of the UL subband in the first time unit according to the first information;
a second determining module configured to determine a third category of the DL subband in the first time unit according to the first information; and
a third determining module configured to determine the first category as the SBFD category in a case where the second category is different from the third category.

In some implementations, the terminal has a plurality of resource configurations.

The first information includes a first field. The first determining module is configured to determine a first resource configuration from the plurality of resource configurations according to the first field, where the first resource configuration includes a first time domain resource configuration; and determine the second category according to the first time domain resource configuration, where the second category is one of the DL category, the UL category, and the F category.

In some implementations, the executing module 720 further includes:

a fourth determining module configured to determine the first category according to the second category in a case where the second category is a same as the third category, where the second category is one of the DL category, the UL category, and the F category.

In some implementations, the fourth determining module is configured to: determine, in a case where the second category and the third category are the DL categories, the first category as the DL category; or determine, in a case where the second category and the third category are the UL categories, the first category as the UL category; or determine, in a case where the second category and the third category are the F categories, the first category as the F category.

In some implementations, the plurality of resource configurations are configured according to second information sent by the network device. One resource configuration corresponds to one index.

In some implementations, the terminal has one resource configuration. The resource configuration includes a first time domain resource configuration.

The first information includes a second field. The first determining module is configured to determine, in a case where a value of the second field is a first value, the second category according to the first time domain resource configuration, where the second category is one of the DL category, the UL category, and the F category; and determine, in a case where the value of the second field is a second value or the second field is null, the second category according to the third category.

In some implementations, the first information includes a third field and a downlink control information format 2-0 (DCI format 2-0) signaling.

The first determining module is configured to determine the second category according to the DCI format 2-0 signaling in a case where the value of the third field is a first value.

The first information includes a second time domain resource configuration.

The second determining module is configured to:

determine the third category according to the second time domain resource configuration, where the third category is one of the DL category, the UL category, and the F category.

In some implementations, the first information includes a DCI format 2-0 signaling.

The first determining module is configured to determine the second category according to the DCI format 2-0 signaling, where the second category is one of the DL category, the UL category, and the F category.

The second determining module is configured to determine the third category according to the DCI format 2-0 signaling, where the third category is one of the DL category, the UL category, and the F category.

In some implementations, a number of the first time unit is M. A number of the second category is M. A number of the third category is M. The first communication device 700 further includes:

a first determining module configured to determine categories of 2M time units according to the DCI format 2-0 signaling.

The first determining module is configured to:

determine M second categories according to categories of odd time units of the categories of the 2M time units.

The second determining module is configured to:

determine M third categories according to categories of even time units of the categories of the 2M time units.

In some implementations, the first information includes a fourth field and a fifth field. The fourth field indicates a first time range. The first time range includes a first time unit of which a category is the SBFD category.

The executing module 720 includes:

a fourth determining module configured to determine, according to a fifth field, to modify a category of a first time unit, and obtain a first category; or determine, according to the fifth field, not to modify the category of the first time unit, and determine the first category as the SBFD category.

In some implementations, the first information is a DCI signaling. The fifth field is a newly added field or a redundant field in the DCI signaling.

The fourth determining module is configured to:
determine, in a case where a value of the fifth field is a first value, to modify the category of the first time unit to the DL category; and
determine, in a case where the value of the fifth field is a second value or the fifth field is null, not to modify the category of the first time unit.

In some implementations, the DCI signaling is a DCI format 1-1 signaling. The fifth field is configured to indicate whether a reserved resource is activated. The reserved resource is the category of the first time unit.

In some implementations, the first information includes DCI indication type 0 frequency domain allocation.

The fifth field is a frequency domain resource allocation field. The fourth determining module is configured to:

determine a first resource block group (RBG) set according to the fifth field, where the first RBG set includes a first RBG, and a frequency domain of the first RBG does not overlap with the DL subband; and modify a category of the first time unit to the DL category.

In some implementations, the first information includes DCI indication type 1 frequency domain allocation.

The fifth field includes a first frequency domain resource allocation field and a second frequency domain resource allocation field. The fourth determining module is configured to determine a first frequency domain resource according to the first frequency domain resource allocation field and the second frequency domain resource allocation field, where the first frequency domain resource is discontinuous, the first frequency domain resource includes a first physical resource block (PRB), and a frequency domain of the first PRB does not overlap with the DL subband; and

modify the category of the first time unit to the DL category.

In some implementations, the fourth determining module is configured to:

determine a second frequency domain resource according to the first frequency domain resource allocation field; determine a third frequency domain resource according to the second frequency domain resource allocation field; and determine a union set of the second frequency domain resource and the third frequency domain resource as the first frequency domain resource.

In some implementations, the fourth determining module is configured to: determine a second frequency domain resource according to the first frequency domain resource allocation field; determine a third frequency domain resource according to the second frequency domain resource allocation field; and determine a complementary set of the second frequency domain resource in the third frequency domain resource as the first frequency domain resource, in a case where the second frequency domain resource is a proper subset of the third frequency domain resource.

In some implementations, each resource configuration further includes at least one of a first frequency domain resource configuration of the UL subband, a second frequency domain resource configuration of the DL subband, or a third frequency domain resource configuration of the carrier component (CC).

In some implementations, the first communication device 700 further includes:

a second determining module configured to determine, according to the first information, a first frequency domain resource configuration for transmitting a UL signal and a second frequency domain resource configuration for transmitting a DL signal in the first time unit.

In some implementations, the first communication device 700 further includes:

a transmitting module configured to transmit the UL signal according to the first frequency domain resource configuration, and transmit the DL signal according to the second frequency domain resource configuration in a case where the first category is the SBFD category.

In a particular implementation, the above first communication device 700 may be the terminal 101 shown in FIG. 3. The receiving module 710 may be a transceiver of the terminal 101. The executing module 720 may be a processor of the terminal 101.

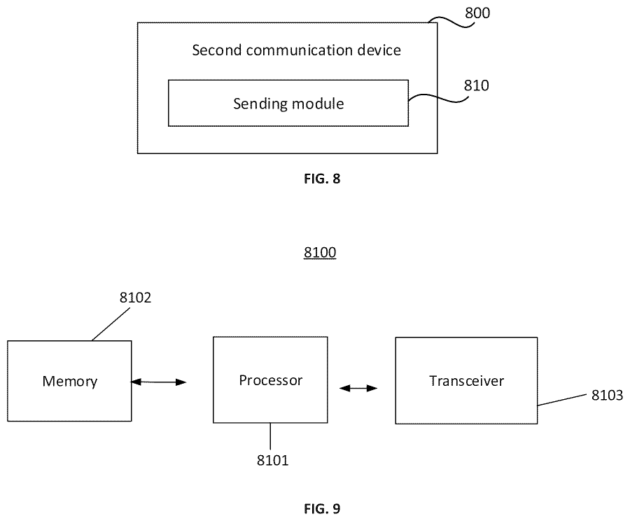

FIG. 8 is a schematic structural diagram of a second communication device according to an embodiment of the present disclosure. As shown in FIG. 8, the second communication device 800 includes:

a sending module configured to send first information to a terminal, where the first information is configured to indicate a first category of a first time unit of a carrier component (CC), and the first category is one of a subband full duplex (SBFD) category, a downlink (DL) category, an uplink (UL) category, and a flexible (F) category.

In some implementations, the first information is further configured to indicate a first frequency domain resource configuration for transmitting a UL signal and a second frequency domain resource configuration for transmitting a DL signal in the first time unit.

In some implementations, a frequency domain of the carrier component (CC) includes an uplink (UL) subband and a downlink (DL) subband.

The first information is configured to indicate the second category of the UL subband in the first time unit and the third category of the DL subband in the first time unit.

The first information is configured to indicate the first category as the SBFD category by indicating that the second category is different from the third category, or the first information is configured to indicate the first category as one of the DL category, the UL category, and the F category by indicating that the second category is a same as the third category.

In some implementations, the second communication device 800 may further include a processing module, etc.

In some implementations, the terminal has a plurality of resource configurations.

The processing module is configured to indicate, by configuring a first field in the first information, that the terminal determines a first resource configuration from the plurality of resource configurations. The first resource configuration includes a first time domain resource configuration. The first time domain resource configuration is configured to determine the second category. The second category is one of the DL category, the UL category, or the F category.

In some implementations, the terminal has one resource configuration. The resource configuration includes a first time domain resource configuration.

The processing module is configured to indicate, by configuring the value of the second field in the first information to be the first value, that the terminal determines the second category according to the first time domain resource configuration. The second category is one of the DL category, the UL category, or the F category.

The processing module is configured to indicate, by configuring the value of the second field in the first information to be the second value or the second field to be null, that the terminal determines the second category according to the third category.

In some implementations, the processing module is configured to configure the first information to include a third field and a downlink control information format 2-0 (DCI format 2-0) signaling.

The processing module is configured to indicate, by configuring the value of the third field in the first information to be the first value, that the terminal determines the second category according to the DCI format 2-0 signaling.

In some implementations, the processing module is configured to configure the first information to include the DCI format 2-0 signaling.

The first information is configured to indicate the second category according to the DCI format 2-0 signaling. The second category is one of the DL category, the UL category, and the F category.

The first information is configured to indicate the third category according to the DCI format 2-0 signaling. The third category is one of the DL category, the UL category, and the F category.

In some implementations, the processing module is configured to configure the first information to be a DCI signaling. The DCI signaling includes a fourth field and a fifth field. The fourth field indicates a first time range. The first time range includes a first time unit of which the category is the SBFD category. The fifth field is configured to indicate whether to activate a reserved resource. The reserved resource is the category of the first time unit.

The processing module is configured to indicate, by configuring a value of the fifth field to be a first value, that the reserved resource is not activated, to indicate that the terminal modifies the category of the first time unit to the DL category.

The processing module is configured to indicate, by configuring the value of the fifth field to be a second value or by configuring the fifth field to be null, that the reserved resource is activated, to indicate that the terminal does not modify the category of the first time unit.

In a particular implementation, the above second communication device 800 may be the network device 102 shown in FIG. 3. The sending module 810 may be a transceiver of the network device 102. The processing module may be a processor of the network device 102.

A specific method for performing an operation by each module of the device in the above embodiments is described in detail in the embodiments related to the method, and is not repeated here.

In an example, the present disclosure further provides a communication system. The communication system may include a first communication device 700 and a second communication device 800.

In an example, the present disclosure further provides a computer-readable storage medium. The computer-readable storage medium stores computer instructions. The computer instructions, when run on a communication device, cause the communication device to perform the method for configuring a resource involving a terminal in the aforementioned embodiment of the present disclosure, or perform the method for configuring a resource involving a network device in the aforementioned embodiment.

FIG. 9 is a schematic structural diagram of a communication device 8100 according to an embodiment of the present disclosure. The communication device 8100 may be a network device (such as an access network device and a core network device), a terminal (such as user equipment), a chip, a chip system, or a processor that supports a network device to implement any one of the above methods, or a chip, a chip system, or a processor that supports a terminal to implement any one of the above methods. The communication device 8100 may be configured to implement the method described in the above method embodiments. Details can be obtained with reference to the descriptions in the above method embodiments.

As shown in FIG. 9, the communication device 8100 includes one or more processors 8101. The one or more processors 8101 are configured to invoke computer instructions to cause the communication device 8100 to perform any of the above methods.

Optionally, the communication device 8100 further includes one or more memories 8102 for storing computer instructions. In an optional embodiment, all or some of the memories 8102 may be located outside the communication device 8100.

Optionally, the communication device 8100 further includes one or more transceivers 8103. In a case where the communication device 8100 includes one or more transceivers 8103, communication steps such as sending and receiving in the above methods are performed by the transceiver 8103, and other steps are performed by the processor 8101.

The communication device 8100 in the descriptions of the above embodiments may be a network device or a terminal, but the scope of the communication device 8100 described in the present disclosure is not restrictive. The structure of the communication device 8100 may not be limited by FIG. 9. The communication device may be an independent device or may be a part of a large device. For example, the communication device may be (1) an independent integrated circuit (IC), a chip, a chip system, or a chip subsystem; (2) a set having one or more ICs, the above IC set alternatively being capable of including memory components for storing data and computer programs; (3) an application-specific integrated circuit (ASIC), such as a modem; (4) a module capable of being embedded within another device; (5) a receiver, a terminal device, an intelligent terminal device, a cellular phone, a wireless device, a handset, a mobile unit, an in-vehicle device, a network device, a cloud device, or an artificial intelligence device, etc.; or (6) another device, etc.

The above communication device 8100 may be a chip or a chip system, but is not restrictive. For example, the communication device 8100 may be an independent electronic device or may be a part of an independent electronic device. For example, in an embodiment, the electronic device may be an integrated circuit (IC) or a chip, where the integrated circuit may be an IC or a set of a plurality of ICs. The chip may include, but is not limited to, categories as follows: a graphics processing unit (GPU), a central processing unit (CPU), a field programmable gate array (FPGA), a digital signal processor (DSP), an application specific integrated circuit (ASIC), a system on chip (SOC), etc. The above integrated circuit or chip may be configured to execute executable instructions (or codes) to implement the above method for configuring a resource. The executable instructions may be stored in the integrated circuit or chip, or acquired from another device or device. For example, the integrated circuit or chip includes a processor, a memory, and an interface for communication with another device. The executable instructions may be stored in the processor. The executable instructions, when executed by the processor, implement the above method for configuring a resource. Or the integrated circuit or chip may receive the executable instructions via the interface and transmit the executable instructions to the processor to execute the executable instructions, to implement the above method for configuring a resource.

As used herein, the term processor may refer to one processor that performs the defined functions or a plurality of processors that collectively perform defined functions, such that the execution of the individual defined functions may be divided amongst such processors.

The present disclosure further provides a non-transitory computer-readable storage medium. The readable storage medium stores computer instructions. The above computer instructions, when executed on the communication device 8100, cause the communication device 8100 to perform any one of the above methods for configuring a resource. Optionally, the above computer-readable storage medium may be a non-transitory computer-readable storage medium or a transitory computer-readable storage medium.

The present disclosure further provides a computer program product. The above computer program product, when executed by the communication device 8100, causes the communication device 8100 to perform any one of the above methods for configuring a resource.

It can be understood that the first communication device, the second communication device, the communication device, the system for configuring a resource, the computer-readable storage medium, and the computer program product mentioned above are all configured to perform the method provided in the embodiments of the present disclosure. Thus, the beneficial effects that can be achieved by the foregoing can be obtained with reference to the beneficial effects in the corresponding method, and are not repeated here.

A person skilled in the art could easily conceive of other implementation solutions of the present disclosure upon consideration of the description and the present disclosure disclosed in the implementation. The present disclosure is intended to cover any variations, uses or adaptive changes of the present disclosure, which follow the general principles of the present disclosure and include common general knowledge or customary technical means in the art that are not disclosed in the present disclosure. The description and embodiments are regarded as illustrative merely. The true scope and spirit of the present disclosure are indicated by the following claims.

It should be understood that the present disclosure is not limited to a precise structure described above and shown in accompanying drawings, and can have various modifications and changes without departing from the scope of the present disclosure. The scope of the present disclosure is limited by the appended claims merely.

1. A method for configuring a resource, performed by a terminal, the method comprising:
receiving first information sent by a network device; and
determining a first category of a first time unit of a carrier component (CC) according to the first information, wherein the first category is one of a subband full duplex (SBFD) category, a downlink (DL) category, an uplink (UL) category, and a flexible (F) category.

2. The method according to claim 1, wherein a frequency domain of the carrier component (CC) comprises an uplink (UL) subband and a downlink (DL) subband; and determining the first category of the first time unit of the carrier component (CC) according to the first information comprises:
determining a second category of the UL subband in the first time unit according to the first information;
determining a third category of the DL subband in the first time unit according to the first information; and
determining the first category as the SBFD category in a case where the second category is different from the third category.

3. The method according to claim 2, wherein the terminal has a plurality of resource configurations; and in a case where the first information comprises a first field, determining the second category of the UL subband in the first time unit according to the first information comprises:
determining a first resource configuration from the plurality of resource configurations according to the first field, wherein the first resource configuration comprises a first time domain resource configuration; and
determining the second category according to the first time domain resource configuration, wherein the second category is one of the DL category, the UL category, and the F category.

4. The method according to claim 1, wherein
a frequency domain of the carrier component (CC) comprises an uplink (UL) subband and a downlink (DL) subband; and
determining the first category of the first time unit of the carrier component (CC) according to the first information comprises:
determining a second category of the UL subband in the first time unit according to the first information;
determining a third category of the DL subband in the first time unit according to the first information; and
determining, in a case where the second category is a same as the third category, the first category as one of the following:
determining the first category as the DL category in a case where the second category and the third category are the DL categories;
determining the first category as the UL category in a case where the second category and the third category are the UL categories; or
determining the first category as the F category in a case where the second category and the third category are the F categories.

5. (canceled)

6. The method according to claim 3, wherein the plurality of resource configurations are configured according to second information sent by the network device, and one resource configuration corresponds to one index.

7. The method according to claim 2, wherein the terminal has one resource configuration, and the resource configuration comprises a first time domain resource configuration; and in a case where the first information comprises a second field, determining the second category of the UL subband in the first time unit according to the first information comprises:
determining the second category according to the first time domain resource configuration in a case where a value of the second field is a first value, wherein the second category is one of the DL category, the UL category, and the F category; and
determining the second category according to the third category in a case where the value of the second field is a second value or the second field is null.

8. The method according to claim 2, wherein the first information comprises a third field and a downlink control information format 2-0 (DCI format 2-0) signaling; and determining the second category of the UL subband in the first time unit according to the first information comprises:
determining the second category according to the DCI format 2-0 signaling in a case where the value of the third field is a first value.

9. The method according to claim 2, wherein the first information comprises a second time domain resource configuration; and determining the third category of the DL subband in the first time unit according to the first information comprises:
determining the third category according to the second time domain resource configuration, wherein the third category is one of the DL category, the UL category, and the F category.

10. The method according to claim 2, wherein the first information comprises a DCI format 2-0 signaling;
determining the second category of the UL subband in the first time unit according to the first information comprises: determining the second category according to the DCI format 2-0 signaling, wherein the second category is one of the DL category, the UL category, and the F category; and
determining the third category of the DL subband in the first time unit according to the first information comprises: determining the third category according to the DCI format 2-0 signaling, wherein the third category is one of the DL category, the UL category, and the F category.

11. The method according to claim 10, wherein a number of the first time unit is M, a number of the second category is M, and a number of the third category is M; the method further comprises:
determining categories of 2M time units according to the DCI format 2-0 signaling;
determining the second category according to the DCI format 2-0 signaling comprises: determining M second categories according to categories of odd time units of the categories of the 2M time units;
determining the third category according to the DCI format 2-0 signaling comprises: determining M third categories according to categories of even time units of the categories of the 2M time units; and
M is an integer greater than 0.

12. The method according to claim 1, wherein the first information comprises a fourth field and a fifth field, the fourth field indicates a first time range, and the first time range comprises a first time unit of which a category is the SBFD category; and determining the first category of the first time unit of the carrier component (CC) according to the first information comprises:
determining to modify the category of the first time unit according to the fifth field and obtaining the first category; or
determining not to modify the category of the first time unit according to the fifth field and determining the first category as the SBFD category.

13. The method according to claim 12, wherein the first information is a DCI signaling, and the fifth field is a newly added field or a redundant field in the DCI signaling; determining, according to the fifth field, to modify the category of the first time unit, and obtaining the first category comprises: determining, in a case where a value of the fifth field is a first value, to modify the category of the first time unit to the DL category; and
determining, according to the fifth field, not to modify the category of the first time unit, and determining the first category as the SBFD category comprises: determining, in a case where the value of the fifth field is a second value or the fifth field is null, not to modify the category of the first time unit.

14. The method according to claim 13, wherein the DCI signaling is a DCI format 1-1 signaling, the fifth field is configured to indicate whether a reserved resource is activated, and the reserved resource is the category of the first time unit.

15. The method according to claim 12, wherein the first information comprises DCI indication type 0 frequency domain allocation; and in a case where the fifth field is a frequency domain resource allocation field, determining to modify the category of the first time unit according to the fifth field and obtaining the first category comprises: determining a first resource block group (RBG) set according to the fifth field, wherein the first RBG set comprises a first RBG, and a frequency domain of the first RBG does not overlap with a downlink (DL) subband; and modifying the category of the first time unit to the DL category; or
the first information comprises DCI indication type 1 frequency domain allocation; and in a case where the fifth field comprises a first frequency domain resource allocation field and a second frequency domain resource allocation field, determining to modify the category of the first time unit according to the fifth field and obtaining the first category comprises: determining a first frequency domain resource according to the first frequency domain resource allocation field and the second frequency domain resource allocation field, wherein the first frequency domain resource is discontinuous, the first frequency domain resource comprises a first physical resource block (PRB), and a frequency domain of the first PRB does not overlap with the downlink (DL) subband; and modifying the category of the first time unit to the DL category.

16. (canceled)

17. The method according to claim 15, wherein determining the first frequency domain resource according to the first frequency domain resource allocation field and the second frequency domain resource allocation field comprises: determining a second frequency domain resource according to the first frequency domain resource allocation field; determining a third frequency domain resource according to the second frequency domain resource allocation field; and
determining a union set of the second frequency domain resource and the third frequency domain resource as the first frequency domain resource; or
determining the first frequency domain resource according to the first frequency domain resource allocation field and the second frequency domain resource allocation field comprises: determining a second frequency domain resource according to the first frequency domain resource allocation field; determining a third frequency domain resource according to the second frequency domain resource allocation field; and determining a complementary set of the second frequency domain resource in the third frequency domain resource as the first frequency domain resource, in a case where the second frequency domain resource is a proper subset of the third frequency domain resource.

18. (canceled)

19. The method according to claim 3, wherein each of the plurality of resource configurations further comprises at least one of a first frequency domain resource configuration of the UL subband, a second frequency domain resource configuration of the DL subband, or a third frequency domain resource configuration of the carrier component (CC).

20. The method according to claim 1, further comprising:
determining, according to the first information, a first frequency domain resource configuration for transmitting a UL signal and a second frequency domain resource configuration for transmitting a DL signal in the first time unit.

21. (canceled)

22. A method for configuring a resource, performed by a network device, the method comprising:
sending first information to a terminal, wherein the first information is configured to indicate a first category of a first time unit of a carrier component (CC), and the first category is one of a subband full duplex (SBFD) category, a downlink (DL) category, an uplink (UL) category, and a flexible (F) category.

23-24. (canceled)

25. A communication device, comprising:
one or more processors; and
a memory that stores computer instructions, wherein the computer instructions, when collectively executed by the one or more processors, cause the communication device:
receive first information sent by a network device; and
determine a first category of a first time unit of a carrier component (CC) according to the first information, wherein the first category is one of a subband full duplex (SBFD) category, a downlink (DL) category, an uplink (UL) category, and a flexible (F) category.

26. (canceled)

27. A non-transitory computer-readable storage medium storing computer instructions, wherein the computer instructions, when collectively executed by one or more processors, cause the one or more processors to perform the method for configuring a resource according to claim 1.
